(19) United States
(12) Patent Application Publication
(10) Pub. No.: US 2018/0231946 A1
(43) Pub. Date: Aug. 16, 2018

(54) Methods, Systems, and Devices for Monitoring and Controlling Tools

(71) Applicant: Tetrascience, Inc., Somerville, MA (US)

(72) Inventors: Salvatore Savo, Somerville, MA (US); Alok Tayi, Somerville, MA (US); Siping Wang, Somerville, MA (US); Peng Wei, Somerville, MA (US)

(21) Appl. No.: 15/750,404

(22) PCT Filed: Aug. 5, 2016
(86) PCT No.: PCT/US16/45770

§ 371 Date: Feb. 5, 2018

Related U.S. Application Data
(60) Provisional application No. 62/201,288, filed on Aug. 5, 2015.

(51) Int. Cl. G05B 19/042; G05B 19/418

(52) U.S. Cl. CPC G05B 19/0425; G05B 19/4185; G05B 2219/2656; G05B 2219/2651; G05B 2219/25187; G05B 2219/15117

(57) ABSTRACT

Methods, systems, and devices for monitoring and controlling tools are provided. In general, the methods, systems, and devices can electronically receive data regarding one or more tools being used to perform a process, e.g., a scientific process, can analyze the received data, and can electronically provide the received and/or analyzed data to one or more users via one or more external devices. Electronically providing the data to the user(s) can include providing the data over a network. In at least some embodiments, a control box is provided that can be configured to electronically couple to one or more external tools. The control box can be configured to communicate over a network with at least one external device. The control box, the tool(s), and the at least one external device can define a network of physical objects so as to be an application of the Internet of Things.

### CROSS REFERENCE TO RELATED APPLICATIONS

The present application claims priority to U.S. Provisional Patent Application No. 62/201,288 entitled “Methods, Systems, And Devices For Monitoring And Controlling Tools” filed Aug. 5, 2015, which is hereby incorporated by reference in its entirety.

### FIELD

Methods, systems, and devices are provided for monitoring and controlling tools.

### BACKGROUND

Scientific experiments typically require monitoring over a period of hours, days, weeks, or months by personnel (e.g., scientists, students, lab assistants, doctors, engineers, etc.) involved in performing the experiment. The monitoring typically includes users checking at the site of the experiment the status of tools being used in the experiment to ensure that the tools are functioning properly and to adjust the position and/or setting of the tools during the course of the experiment. For at least some experiments, such checking must be performed frequently because of the number of tools being used in the experiment and/or because of the nature of the experiment. The monitoring can therefore be burdensome on personnel because of the amount of time required for the personnel to be on site, e.g., in the lab, at school, at work, etc., to monitor the experiment's tools. Even for relatively short duration experiments, the monitoring can be difficult when the number of tools that require monitoring is relatively large, when the number of available personnel to perform the monitoring is small, and/or when specialized training is required to properly monitor a particular tool and someone with that training is not available when the monitoring is needed. For experiments that continuously run over a large number of hours, including over a period of days, it can be difficult for personnel to monitor the experiment's tools throughout the experiment, particularly when the number of personnel is small. For experiments jointly run by personnel in different geographic locations (e.g., co-workers in different offices, researchers at different universities, etc.), the task of tool monitoring and resulting tool adjustments can fall on the personnel local to the site of the experiment, which can be overly burdensome on them.

In at least some experiments, the settings of one or more tools must be changed during the course of the experiment. The changes may be needed for any of a variety of reasons, such as ambient conditions (e.g., humidity, temperature, lighting, etc.) of the experiment's setting changing, as matter involved in the experiment transforms during the normal course of the experiment, as experiment results indicate a more preferred setting, etc. The reason for the change can happen unexpectedly, such as when a building's heating unit malfunctions and thereby results in a cooling of a room in the building, and may not be detected by personnel until some length of time after the reason for the change arises. The affected tool(s) may therefore not be adjusted in a timely fashion, which can adversely affect the experiment and, in at least some instances, require the experiment to be abandoned and restarted. The reason for the change may be an expected reason, such as a temperature of a liquid being heated to reach a certain threshold temperature, but it may occur at any time during a wide range of time. Having personnel waiting on site to deal with this expected change can be time-consuming and costly.

Sometimes a tool unexpectedly malfunctions during the course of an experiment and must be repaired or be replaced with a new tool. However, if personnel is not on site to repair or replace the tool and/or if the tool malfunction is not detected in a timely fashion, the experiment can be adversely affected and, in at least some instances, require the experiment to be abandoned and restarted.

Tools in contexts other than a scientific experiment context may require monitoring by personnel and/or adjustment during use and accordingly experience issues similar to those discussed above for a scientific experiment context.

Accordingly, there remains a need for improved methods, systems, and devices for monitoring and controlling tools.

### SUMMARY

The present invention generally provides methods, systems, and devices for monitoring and controlling tools. In one embodiment, a device for monitoring and controlling tools is provided that includes a housing having a processor and a wireless communication mechanism disposed therein. The wireless communication mechanism is configured to electronically couple the processor to at least one external tool that is configured to perform at least one of measuring at least one parameter and monitoring at least one parameter, the processor is configured to receive data from the external tool via the wireless communication mechanism that is indicative of the measured at least one parameter and/or the monitored at least one parameter, the processor is configured to provide instructions to the at least one external tool based at least in part on the received data, and the wireless communication mechanism is configured to transmit data to an external device indicative of the data received from the external tool.

The device can vary in any number of ways. For example, the at least one external tool can include a plurality of external tools, and the processor can be configured to switch between controlling different ones of the external tools. The controlling can include the processor providing instructions to the one of the external tools that cause the one of the external tools to perform a function. The function can include at least one of changing physical position, changing on/off state, and changing the one of the external tool's output, and/or the wireless communication mechanism can be configured to receive an instruction from a user indicating which one of the external tools the processor is to control.

For another example, the instructions can instruct the at least one external tool to perform a function.

For yet another example, the processor can be configured to receive data from a camera visualizing the at least one external tool. The data from the camera can be indicative of a condition of the at least one external tool. The wireless communication mechanism can be configured to transmit data to the at least one external device indicative of the data received from the camera. The instructions can instruct the at least one external tool to perform a function based at least in part on the data received from the camera.

For still another example, the housing can include at least one port configured to couple to the at least one external tool, the housing can include a power control unit, the housing is waterproof, and/or a heat sink can be mounted on the housing.

For another example, the at least one external tool can include at least one of a thermometer, a barometer, a humidity measurement device, a camera, a switch, a freezer, an incubator, a syringe pump, a beaker, an autoclave, a hot plate, a hot plate stirrer, a thermocouple, a liquid mixer, a pH measurement device, an oxygen level measurement device, a carbon dioxide measurement device, a voltage measurement device, a current measurement device, a pressure measurement device, a viscosity measurement device, a quantitative polymerase chain reaction (qPCR) measurement device, a weight measurement scale, a power source, a centrifuge, a timer, an oscilloscope, an evaporator, a voltage source, a microscope, a nuclear magnetic resonance (NMR) spectrometer, a Fourier transform infrared (FTIR) spectrometer, a balance, and an orbital shaker.

For yet another example, the housing can be located at a same physical site as the at least one external tool, or the housing can be cloud-based and located remotely from the at least one external tool.

In another embodiment, a device for monitoring and controlling tools includes a fluid-tight housing including a control unit and a wireless communication unit configured to receive data from a plurality of external scientific tools. The received data is indicative of data sensed by the external scientific tools, the wireless communication unit is configured to provide the received data to the control unit, and the wireless communication unit is configured to transmit instructions from the control unit to the plurality of scientific tools.

The device can have any number of variations. For example, the control unit can be configured to cause the wireless communication unit to transmit the instructions to a select one of the scientific tools based on the data sensed by the select one of the scientific tools. The control unit can be configured to cause the wireless communication unit to transmit the instructions to at least one other of the scientific tools based on the data sensed by the select one of the scientific tools.

For another example, the control unit can be configured to cause the wireless communication unit to transmit the instructions to a select one of the scientific tools based on instructions received from a user via the wireless communication unit.

For yet another example, the housing can include a memory storing a plurality of predetermined actions therein. Each of the actions can be associated with one of the plurality of external scientific tools. The processor can be configured to determine if the data received from a one of the external scientific tools triggers any one or more of the predetermined actions associated with the one of the external scientific tool, and if so, to execute the triggered one or more predetermined actions. The triggered one or more predetermined actions can cause the processor to transmit an instruction to the one of the external scientific tools instructing the one of the external scientific tools to perform a function, and/or the triggered one or more predetermined actions can cause the processor to transmit an instruction to another one of the external scientific tools instructing the other one of the external scientific tools to perform a function.

For another example, the control unit can be configured to receive data from a camera visualizing at least one of the scientific tools. The data from the camera can be indicative of a condition of the visualized one or more scientific tools. The control unit can be configured to cause the wireless communication unit to transmit the instructions to at least one of the visualized scientific tools based on the data received from the camera.

For yet another example, the housing can include a power control unit configured to provide power to the control unit, the housing includes a network connector configured to physically connect the control unit to a network, and/or a heat sink can be mounted on the housing.

For still another example, the housing can be located at a same physical site as the at plurality of external scientific tools, or the housing can be cloud-based and located remotely from the plurality of external scientific tools.

For another example, the external tools can include at least two of a thermometer, a barometer, a humidity measurement device, a camera, a switch, a freezer, an incubator, a syringe pump, a beaker, an autoclave, a hot plate, a hot plate stirrer, a thermocouple, a liquid mixer, a pH measurement device, an oxygen level measurement device, a carbon dioxide measurement device, a voltage measurement device, a current measurement device, a pressure measurement device, a viscosity measurement device, a quantitative polymerase chain reaction (qPCR) measurement device, a weight measurement scale, a power source, a centrifuge, a timer, an oscilloscope, an evaporator, a voltage source, a microscope, a nuclear magnetic resonance (NMR) spectrometer, a Fourier transform infrared (FTIR) spectrometer, a balance, and an orbital shaker.

In another embodiment, a device for monitoring and controlling tools is provided that includes a housing having disposed therein a processor configured to electronically communicate with a first tool external to the housing and with a second tool external to the housing, and having disposed therein a wireless communication mechanism. The processor is configured to cause the wireless communication mechanism to wirelessly transmit data received from the first tool to an external device and to cause the wireless communication mechanism to wirelessly transmit data received from the second tool to the external device. The processor is configured to wirelessly receive instructions from the external device. The processor is configured to cause at least one of the first and second tools to perform a function in response to the received instructions.

The device can have any number of variations. For example, the function can include at least one of changing physical position, changing on/off state, and changing output.

For another example, the received instructions can be targeted to the first tool, and the processor can be configured to cause the first tool to perform the function in response to the received instructions without causing the second tool to perform a function in response to the received instructions.

For yet another example, the received instructions can be targeted to the first tool, and the processor can be configured to cause each of the first and second tools to perform a function in response to the received instructions.

For still another example, the received instructions can be targeted to the first tool. The processor can be configured to cause the first tool to perform the function in response to the received instructions. The processor can be configured to determine whether the received instructions satisfy predetermined criteria with respect to the second tool, and if so, to cause the second tool to perform a function in response to the received instructions, and if not, to not cause the second tool to perform a function in response to the received instructions.

For yet another example, the housing can have a memory disposed therein. The memory can store a plurality of predetermined actions therein. Each of the actions can be associated with one of the first tool and the second tool. The processor can be configured to determine if the data received from the first tool triggers any one or more of the predetermined actions associated with the first tool, and if so, to execute the triggered one or more predetermined actions. The processor can be configured to determine if the data received from the second tool triggers any one or more of the predetermined actions associated with the second tool, and if so, to execute the triggered one or more predetermined actions.

For another example, the instructions from the external device can be based on a user input to the external device.

For yet another example, the housing can be waterproof, and/or a heat sink mounted on the housing

For still another example, the external tool can include at least one of a thermometer, a barometer, a humidity measurement device, a camera, a switch, a freezer, an incubator, a syringe pump, a beaker, an autoclave, a hot plate, a hot plate stirrer, a thermocouple, a liquid mixer, a pH measurement device, an oxygen level measurement device, a carbon dioxide measurement device, a voltage measurement device, a current measurement device, a pressure measurement device, a viscosity measurement device, a quantitative polymerase chain reaction (qPCR) measurement device, a weight measurement scale, a power source, a centrifuge, a timer, an oscilloscope, an evaporator, a voltage source, a microscope, a nuclear magnetic resonance (NMR) spectrometer, a Fourier transform infrared (FTIR) spectrometer, a balance, and an orbital shaker.

In another aspect, a system for monitoring and controlling tools is provided that in one embodiment includes a housing and a client terminal external to the housing. The housing has a processor disposed therein and a wireless communication mechanism disposed therein. The processor is configured to electronically communicate with at least one external tool. The client terminal is configured to wirelessly communicate with the processor via the wireless communication mechanism and to cause the wireless communication mechanism to transmit data measured and/or monitored by the at least one external tool to the processor. The client terminal is configured to receive instructions from a user and to transmit instructions to the processor via the wireless communication mechanism that cause the processor to provide instructions to the at least one external tool to perform an activity in accordance with the instructions transmitted by the client terminal to the processor.

The system can vary in any number of ways. For example, the housing and the at least one external tool can be located locally with each other, and the client terminal can be remotely located from the housing and the at least one external tool.

For another example, the housing and the client terminal can each be remotely located from the at least one external tool.

For yet another example, the at least one external tool can include a plurality of external tools, and the client terminal can be configured to select one or more of the external tools and cause the wireless communication mechanism to transmit data measured and/or monitored by the selected external tool to the processor.

For yet another example, the activity performed by the at least one external tool can include at least one of changing its physical position, changing its on/off state, and changing the external tool's output.

For still another example, the at least one external tool can include a plurality of external tools. At least one of the plurality of external tools can include a camera configured to visualize another one of the plurality of external tools. The processor can be configured to cause images gathered by the camera to be transmitted to the client terminal via the wireless communication mechanism.

For another example, the housing can be waterproof and/or a heat sink can be mounted on the housing.

For yet another example, the at least one external tool can be configured to perform a function selected from the group consisting of measuring at least one parameter and monitoring at least one parameter.

For another example, the at least one external tool can include at least one a thermometer, a barometer, a humidity measurement device, a camera, a switch, a freezer, an incubator, a syringe pump, a beaker, an autoclave, a hot plate, a hot plate stirrer, a thermocouple, a liquid mixer, a pH measurement device, an oxygen level measurement device, a carbon dioxide measurement device, a voltage measurement device, a current measurement device, a pressure measurement device, a viscosity measurement device, a quantitative polymerase chain reaction (qPCR) measurement device, a weight measurement scale, a power source, a centrifuge, a timer, an oscilloscope, an evaporator, a voltage source, a microscope, a nuclear magnetic resonance (NMR) spectrometer, a Fourier transform infrared (FTIR) spectrometer, a balance, and an orbital shaker.

In another embodiment, a system for monitoring and controlling tools includes a housing and a camera. The housing has a wireless communication mechanism disposed therein, a processor disposed therein, an input configured to electronically connect to an external tool configured to measure a parameter and/or monitor a parameter, and a power control mechanism configured to provide power to the external tool electronically connected to the input. The camera is configured to wirelessly communicate with the processor via the wireless communication mechanism. The processor is configured to automatically terminate power from the power control mechanism to the external tool in response to the processor receiving predetermined data from the camera.

The system can vary in any number of ways. For example, the processor can be configured to receive an instruction from an external device requesting an adjustment of the external tool. The external device can be located remotely from the housing. The processor can be configured to cause the external tool to adjust in accordance with the received instruction. The processor can be configured to transmit images from the camera to the external device, and/or the adjustment can include at least one of changing the external tool's physical position, changing the external tool's on/off state, and changing the external tool's output.

For another example, the housing can be waterproof, and/or a heat sink can be mounted on the housing.

For yet another example, the external tool can include at least one of a thermometer, a barometer, a humidity measurement device, a camera, a switch, a freezer, an incubator, a syringe pump, a beaker, an autoclave, a hot plate, a hot plate stirrer, a thermocouple, a liquid mixer, a pH measurement device, an oxygen level measurement device, a carbon dioxide measurement device, a voltage measurement device, a current measurement device, a pressure measurement device, a viscosity measurement device, a quantitative polymerase chain reaction (qPCR) measurement device, a weight measurement scale, a power source, a centrifuge, a timer, an oscilloscope, an evaporator, a voltage source, a microscope, a nuclear magnetic resonance (NMR) spectrometer, a Fourier transform infrared (FTIR) spectrometer, a balance, and an orbital shaker.

In another embodiment, a system for monitoring and controlling tools includes a housing and a server. The housing includes a processor disposed therein, a memory disposed therein, and a wireless communication mechanism disposed therein and configured to wirelessly communicate with a plurality of tools that are each external to the housing. The server is external to and remotely located from the housing. The server includes a memory storing a plurality of programming instructions each being unique to one of the plurality of tools. The processor is configured to cause the wireless communication mechanism to wireless transmit data received from each of the plurality of tools to a client terminal that is external to and remotely located from the housing. The processor is configured to receive from the external server the one of the programming instructions unique to a one of the plurality of tools in response to the one of the plurality of tools being wirelessly electronically connected to the housing. The received programming instructions are effective to cause the processor to receive and process data received by the one of the plurality of tools. The received programming instructions are stored in the memory disposed in the housing.

The system can vary in any number of ways. For example, the received programming instructions stored in the memory disposed in the housing can be effective to cause the processor to effect, in response to the data received from the one of the plurality of tools, at least one of a change in physical position of the one of the plurality of tools, change an on/off state of the one of the plurality of tools, and change an output of the one of the plurality of tools. The received programming instructions stored in the memory disposed in the housing can be effective to cause the processor to effect, in response to the data received from the one of the plurality of tools, at least one of a change in physical position of another one of the plurality of tools, change an on/off state of the other one of the plurality of tools, and change an output of the other one of the plurality of tools.

For another example, the received programming instructions stored in the memory disposed in the housing can be effective to cause the processor to effect, in response to the data received from the one of the plurality of tools, an adjustment of a camera visualizing the one of the plurality of tools, the camera being in wireless electronic communication with the wireless communication mechanism.

For yet another example, the housing can be waterproof, and/or a heat sink mounted on the housing.

For still another example, the plurality of tools can include at least two of a thermometer, a barometer, a humidity measurement device, a camera, a switch, a freezer, an incubator, a syringe pump, a beaker, an autoclave, a hot plate, a hot plate stirrer, a thermocouple, a liquid mixer, a pH measurement device, an oxygen level measurement device, a carbon dioxide measurement device, a voltage measurement device, a current measurement device, a pressure measurement device, a viscosity measurement device, a quantitative polymerase chain reaction (qPCR) measurement device, a weight measurement scale, a power source, a centrifuge, a timer, an oscilloscope, an evaporator, a voltage source, a microscope, a nuclear magnetic resonance (NMR) spectrometer, a Fourier transform infrared (FTIR) spectrometer, a balance, and an orbital shaker.

In another aspect, a method of monitoring and controlling tools is provided that in one embodiment includes receiving at a control box an instruction from a client terminal. The client terminal is remotely located from the control box, and the instruction is based on a user input to the client terminal. The method includes the control box causing a first scientific tool that is local to the control box to perform an action based on the received instruction.

The method can have any number of variations. For example, the instruction can be transmitted wirelessly to the control box.

For another example, the control box causing the first scientific tool to perform the action can include the control box wirelessly communicating an instruction to the first scientific tool.

For yet another example, the action performed by the first scientific tool can include at least one of changing physical position, changing on/off state, and changing the first scientific tool's output. The method can include control box causing another one of the plurality of scientific tools to perform an action based on the received instruction that is for the first scientific tool, and/or the method can include receiving at the control box a second instruction from the client terminal. The second instruction can be based on a second user input to the client terminal, the second instruction can be for a second one of the plurality of scientific tools, and the control box can cause the second one of the scientific tools to perform an action based on the received second instruction. The control box can cause another one of the scientific tools to perform an action based on the received second instruction that is for the second one of the scientific tools.

For still another example, the method can include receiving at the control box an image from a camera visualizing the first scientific tool, and transmitting the received image from the control box to the client terminal. The received image can be transmitted wirelessly from the camera to the control box.

For another example, the method can include receiving at the control box data from the first scientific tool indicative of at least one of a parameter measured by the first scientific tool and a parameter monitored by the first scientific tool. The received data can be transmitted wirelessly from the first scientific tool to the control box, and/or the method can include transmitting from the control box to client terminal the data received from the first scientific tool. The data received from the first scientific tool can be transmitted wirelessly from the control box to the client terminal.

For yet another example, the first scientific tool can include at least one of a thermometer, a barometer, a humidity measurement device, a camera, a switch, a freezer, an incubator, a syringe pump, a beaker, an autoclave, a hot plate, a hot plate stirrer, a thermocouple, a liquid mixer, a pH measurement device, an oxygen level measurement device, a carbon dioxide measurement device, a voltage measurement device, a current measurement device, a pressure measurement device, a viscosity measurement device, a quantitative polymerase chain reaction (qPCR) measurement device, a weight measurement scale, a power source, a centrifuge, a timer, an oscilloscope, an evaporator, a voltage source, a microscope, a nuclear magnetic resonance (NMR) spectrometer, a Fourier transform infrared (FTIR) spectrometer, a balance, and an orbital shaker.

Non-transitory computer program products (i.e., physically embodied computer program products) are also provided that store instructions, which when executed by one or more data processors of one or more computing systems, causes at least one data processor to perform operations herein. Similarly, computer systems are also provided that can include one or more data processors and memory coupled to the one or more data processors. The memory can temporarily or permanently store instructions that cause at least one processor to perform one or more of the operations described herein. In addition, methods can be implemented by one or more data processors either within a single computing system or distributed among two or more computing systems. Such computing systems can be connected and can exchange data and/or commands or other instructions or the like via one or more connections, including but not limited to a connection over a network (e.g., the Internet, a wireless wide area network, a local area network, a wide area network, a wired network, and the like.), via a direct connection between one or more of the multiple computing systems, etc.

### BRIEF DESCRIPTION OF DRAWINGS

This invention will be more fully understood from the following detailed description taken in conjunction with the accompanying drawings, in which:

FIG. 1 is a schematic view of one embodiment of a tool monitoring and control system;

FIG. 2 is a schematic view of one embodiment of a network system including the system of FIG. 1;

FIG. 3 is a schematic view of one embodiment of a computer system;

FIG. 4 is a schematic view of another embodiment of a tool monitoring and control system;

FIG. 5 is a schematic view of yet another embodiment of a tool monitoring and control system;

FIG. 6 is a perspective view of one embodiment of a control box of a tool monitoring and control system;

FIG. 7 is another perspective view of the control box of FIG. 6;

FIG. 8 is another perspective view of the control box of FIG. 6;

FIG. 9 is an end view of the control box of FIG. 6;

FIG. 10 is a side view of the control box of FIG. 6;

FIG. 11 is another end view of the control box of FIG. 6;

FIG. 12 is a schematic diagram showing one embodiment of a user interface of a tool monitoring and control system;

FIG. 13 is a schematic diagram showing another embodiment of a user interface of a tool monitoring and control system;

FIG. 14 is a schematic diagram showing yet another embodiment of a user interface of a tool monitoring and control system;

FIG. 15 is a schematic diagram showing still another embodiment of a user interface of a tool monitoring and control system; and

FIG. 16 is a schematic diagram showing yet another embodiment of a user interface of a tool monitoring and control system.

### DETAILED DESCRIPTION

Certain exemplary embodiments will now be described to provide an overall understanding of the principles of the structure, function, manufacture, and use of the devices and methods disclosed herein. One or more examples of these embodiments are illustrated in the accompanying drawings. Those skilled in the art will understand that the devices and methods specifically described herein and illustrated in the accompanying drawings are non-limiting exemplary embodiments and that the scope of the present invention is defined solely by the claims. The features illustrated or described in connection with one exemplary embodiment may be combined with the features of other embodiments. Such modifications and variations are intended to be included within the scope of the present invention.

Further, in the present disclosure, like-named components of the embodiments generally have similar features, and thus within a particular embodiment each feature of each like-named component is not necessarily fully elaborated upon. Additionally, to the extent that linear or circular dimensions are used in the description of the disclosed systems, devices, and methods, such dimensions are not intended to limit the types of shapes that can be used in conjunction with such systems, devices, and methods. A person skilled in the art will recognize that an equivalent to such linear and circular dimensions can easily be determined for any geometric shape. Sizes and shapes of the systems and devices, and the components thereof, can depend at least on the anatomy of the subject in which the systems and devices will be used, the size and shape of components with which the systems and devices will be used, and the methods and procedures in which the systems and devices will be used.

Various exemplary methods, systems, and devices for monitoring and controlling tools are provided. In general, the methods, systems, and devices can electronically receive data regarding one or more tools being used to perform a process, e.g., a scientific process, can analyze the received data, and can electronically provide the received and/or analyzed data to one or more users via one or more external devices. Electronically providing the data to the user(s) can include providing the data over a network, such as via web page or app, thereby allowing for remote user access. In other words, the one or more users can monitor and control the one or more tools without the user(s) being physically present with the tool(s) and/or without the tool(s) being in a line of sight of the user(s). Thus, the methods, systems, and devices can give the user(s) flexibility in managing the tool(s) and the overall context in which the tool(s) are being used, e.g., a scientific experiment context, can allow multiple users to each have access to current and/or historical data regarding the tool(s), and/or can help the user(s) become aware of and address any anomalies with the tool(s) in real time with the methods, systems, and devices detecting such anomalies.

In an exemplary embodiment, a control box is provided that can be configured to electronically couple (wired or wirelessly) to one or more tools located outside of the control box, which can be a self-contained unit. The control box can be configured to communicate (wired or wirelessly) over a network with at least one external device (e.g., a server, a desktop computer, a mobile phone, a tablet computer, a laptop computer, etc.) located external to the control box, and in at least some embodiments, located remotely from the control box. The control box, the tool(s), and the at least one external device can define a network of physical objects so as to be an application of the Internet of Things, as will be appreciated by a person skilled in the art. The at least one external device can thus be provided with network access to data received at the control box from the tool(s), thereby allowing user(s) of the at least one external device to view the tool data even when the user(s) are not physically at the site of the tool(s). The control box can be configured to electronically couple to any number of tools, which can help provide scalability.

The control box can be configured to receive tool-specific information related to each of the tools electronically coupled thereto, thereby allowing the control box to efficiently and effectively manage the tools and analyze the data received therefrom. The control box can be configured to automatically receive the tool-specific information from an external device in response to the tool being electronically coupled to the control box (e.g., data automatically downloaded to the control box from a server in response to the tool's coupling to the control box, etc.). This information process can be transparent to users, which can make tool connection and use a simple process for users since the users need not enter any data into a computer system or otherwise input setup data for the tool. The control box can be configured, however, to allow the user to input and/or edit setup data for tools in order for the user to customize tool monitoring and control for their particular use of the tools.

The control box can be configured to analyze the data received from the tool(s), such as determining trends in the data over time, detecting data that meets predetermined alarm criteria so as to indicate an alarm condition, and determining that a received data value from one tool coupled to the control box triggers an action to be performed by that tool and/or another tool coupled to the control box. The control box can be configured to provide analyzed data to the at least one external device, and hence to the user(s) of the at least one external device, over the network, which can allow the user(s) to be aware of the current and/or historical status of the tool(s) and/or can allow the user(s) to take corrective action to address an alarm condition identified by the control box. The control box can be configured to provide instructions to the tool(s) coupled thereto that cause the instructed tool to perform an action such as adjusting its physical position, changing its on/off state, or adjusting its output. The control box can be configured to automatically provide the instructions based on the data received from the tools and/or the control box can be configured to provide the instructions in response to a request received from the at least one external device for one or more of the tools coupled to the control box to perform an action. The control box automatically providing the instructions can help reduce time and analysis burdens on user(s) managing the tool(s) and/or can help ensure that the actions are performed in a timely manner since a user need not physically manipulate the tool to enact the action and need not even be aware that the action was taken until after it already occurred. The control box providing the instructions in response to the external device's request (e.g., at the user's request) can help the user(s) control the tool(s) in accordance with their preferences. In an exemplary embodiment, the control box can be configured to automatically provide instructions in response to preprogrammed triggers and to provide instructions on-demand in response to requests from external devices.

The methods, systems, and devices described herein can be used for monitoring and controlling a variety of tools. In at least some embodiments, the tools can include scientific instruments configured to be used in the course of performing a scientific experiment. Non-limiting examples of scientific tools that can be monitored and controlled using the methods, systems, and devices described herein include thermometers, barometers, humidity measurement devices, cameras (e.g., webcams, video cameras, cameras configured to take still images, infrared camera, etc.), switches, freezers, incubators, syringe pumps, beakers, autoclaves, hot plates, hot plate stirrers, thermocouples, liquid mixers, pH measurement devices, oxygen level measurement devices, carbon dioxide measurement devices, voltage measurement devices, current measurement devices, pressure measurement devices, viscosity measurement devices, quantitative polymerase chain reaction (qPCR) measurement devices, weight measurement scales, power sources, centrifuges, timers, oscilloscopes, digital storage oscilloscopes, dual beam oscilloscopes, evaporators, voltage sources, microscopes, confocal microscopes, comparison microscopes, fluorescence microscopes, light sheet fluorescence microscopes, nuclear magnetic resonance (NMR) spectrometers, Fourier transform infrared (FTIR) spectrometers, balances, orbital shakers, sensors (e.g., for gases, liquids, plasmas, solids, and/or solutions), robots, high-throughput screeners, plate readers, water baths, agar plates, pipettes, combustion pipettes, signal generators, mass balances, aspirators, pumps, calorimeters, thermogravimetric analyzers, biosafety cabinets, blenders, Bunsen burners, burettes, centrifugal evaporators, centrifugal extractors, clinostats, Cobas Mira analyzers, Colony counters, colorimeters, cassette pumps, irculators, comb generators, cone calorimeter, cork borers, coulter counters, crucibles, cutting mills, cytometry devices, dasymeters, dean-stark apparatuses, dispomix technologies, distortion meters, drierites, drop tubes, du Noiiy ring methods, Durrum D-500 analyzers, ebulliometers, ebullioscopes, eco funnels, environmental test chambers, electronic noses, emergency showers, fibre multi-object spectrographs, filter funnels, filter papers, fine adjustment screws, fisher-porter tubes, flow injection analysis devices, fluctuation-enhanced sensing devices, flow cytometers, fluorometers, flynaps, forward pipetting devices, free fall machines, french pressure cell presses, fume hoods, gas collecting tubes, gas pycnometers, Geiger counters, genequants, general Antiparticle spectrometers, gloveboxes, goniometers, gooch crucibles, heated baths, heating mantles, heatproof mats, hemocytometers, high-shear mixers, homogenizers, hose barbs, hot air ovens, hot cells, hydrometers, imaging particle analyzers, incubators (e.g., mammalian, microbial cell culture, or animal), inductive couplers, plasma atomic emission spectroscopies, inductively coupled plasma mass spectrometry devices, inoculation loops, instruments used in medical laboratories, integrated fluorometers, ionometers, ionsensers, iron rings (laboratory), kaliapparats, kelvin-varley dividers, Kipp's apparatuses, Koenig's manometric flame apparatuses, kugelrohrs, laboratory robotics, laboratory baths, laboratory centrifuges, vacuum dry boxes, laboratory ovens, laboratory tubes, laminar flow cabinets, Langmuir-Blodgett troughs, lattice light-sheet microscopies, lecture bottles, line impedance stabilization networks, live cell imaging devices, lock-in amplifiers, lovibond comparators, magnetic stirrers, marx generators, matrasses, McIntosh and Filde's anaerobic jars, McLeod gauges, media dispensers, Meker-Fisher burners, melting point apparatuses, mercury vacuums, microbalances, microchannel plate detectors, microtiter plates, mortars and pestles, multifocal plane microscopy devices, Nanalysis instruments, nanotiters, network analyzers (electrical), oil baths, operant conditioning chambers, optical spectrometers, optical tables, parallel-plate flow chambers, Perkin triangles, phonodeiks, picotiter plates, pipeclay triangles, pneumatic troughs, pressure reactors, qubit fluorometers, radio-frequency sweeps, random positioning machines, rate sensors, reaction calorimeters, Reiss spirals, retort stands, rockers (laboratory), rotary evaporators, sand baths, flow cell scanners, mobility particle sizer scanners, Schlenk lines, Schlenk-frits, scientific glassblowers, scoopulas, semiconductor curve tracers, phage-triggered ion cascades scanners, separatory funnels, serum-separating tubes, shakers (laboratory), shock tubes, Shortix devices, signal analyzers, signal generators, slotted lines, solvent cabinets, sorbent tubes, spectrofluorometers, spectrophotometers, spectrum analyzers, cell spinners, splints (laboratory equipment), static mixers, steristoppers, distillation apparatuses, survey meters, syringe drivers, syringe filters, syringe pumps, teclu burners, and tensiometers. The scientific tools can each be configured to perform at least one of measuring at least one parameter (e.g., temperature, humidity, pressure, pH, O₂ level, CO₂ level, H₂ level, amplitude, pulse width, current, voltage, resistance, impedance, frequency, viscosity, luminance, weight, velocity, stir rate, etc.) and monitoring at least one parameter.

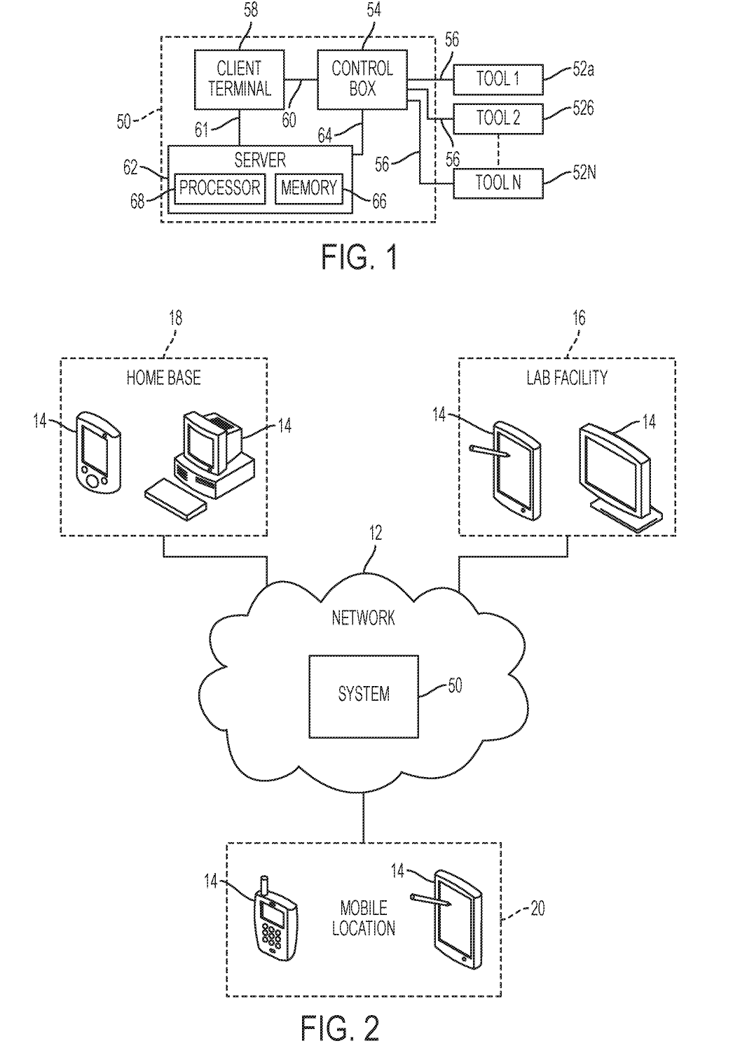

FIG. 1 illustrates one embodiment of a system 50 configured to facilitate monitoring and controlling one or more tools 52a, 52b, 52N configured to be selectively coupled to the system 50. This illustrated embodiment includes “N” number of tools (N>3), but the system 50 can be configured to facilitate monitoring and controlling any number of tools. The system 50 can include a control box 54 configured to electronically communicate with the tools 52a, 52b, 52N along at least one communication line 56, a client terminal 58 configured to directly electronically communicate with the control box 54 along at least one communication line 60 (e.g., via a communication protocol such as Bluetooth, etc.), and a server 62 configured to electronically communicate with the control box 54 along at least one communication line 64. In addition to or instead of directly communicating with the control box 54, the client terminal 58 can be configured to indirectly electronically communicate with the control box 54 through the server 62 along at least one communication line 61 with the server 62, which can be configured to communicate with the control box 54 via the at least one communication line 64.

The communication lines 56, 60, 64 can each be wired communication lines or wireless communication lines. The at least one communication line 56 can be wired for at least one of the tools 52a, 52b, 52N and wireless for a remainder of the tools 52a, 52b, 52N, can be wired for all of the tools 52a, 52b, 52N, or can be wireless for all of the tools 52a, 52b, 52N. To facilitate connecting tool(s) to the control box 54 using at least one communication line 56 as a wired connection, the control box 54 can include one or more IO interfaces (not shown), e.g., USB ports, RS232 interfaces, RS422 interfaces, RS484 interfaces, IEEE488 interfaces, etc., configured to facilitate wired connection of one or more tools thereto. If a tool does not already include the ability to physically connect to a computer system, the tool can be retrofitted with an adapter to allow such connection. To facilitate connecting tool(s) to the control box 54 using at least one communication line 56 as a wireless connection, the control box 54 can include a wireless communication unit (not shown) and each of the wirelessly connectable tool(s) can include a wireless communication unit configured to communicate with the control box's wireless communication unit. Existing tools can be retrofitted with a wireless communication unit, thereby facilitating use of the tools with the system 50. In some embodiments, the control box 54 can include a wireless communication unit contained therein, while in other embodiments, the control box 54 can be configured to achieve wireless communication via an external wireless communication unit coupled thereto, such as by connection thereto via USB port. In an exemplary embodiment, the at least one communication line 60 between the control box 54 and the client terminal 58 can be wireless, e.g., Bluetooth, WiFi, etc., which can facilitate the client terminal 58 being remotely located from the control box 54, e.g., located in different buildings, located in different cities, located in different countries, etc. The control box 54 can thus be configured to facilitate remote monitoring and controlling the tools 52a, 52b, 52N by the client terminal 58. The tools 52a, 52b, 52N can each include an instrument configured to be used in the course of performing a scientific experiment, as discussed herein. The control box 54 can thus be configured to facilitate remote monitoring and controlling a scientific experiment involving the tools 52a, 52b, 52N. In an exemplary embodiment, the at least one communication line 64 between the control box 54 and the server 62 can be wireless, which can facilitate the server 62 being remotely located from the control box 54. This illustrated embodiment includes one client terminal 58 and one server 62, but the system 50 can include a plurality of client terminals and/or a plurality of servers.

The control box 54 can be configured to analyze the data received from the tools 52a, 52b, 52N (e.g., data indicative of a parameter measured or monitored by a tool, such as data gathered by a sensor of the tool; data indicative of a day/time a tool was used; or data indicative of a constant parameter related to a tool, such as model number, total number of possible inputs to the tool, and manufacturer name) and can be configured to provide the received data and/or results of the analysis to the client terminal 58 via the at least one communication line 60. The control box 54 can be configured to transmit the data to the client terminal 58 on a predetermined schedule (e.g., hourly, daily, etc.) for any or all of the tools 52a, 52b, 52N (with the same predetermined schedule being used for all the tools 52a, 52b, 52N or different predetermined schedules being used for different ones of the tools 52a,52b, 52N), the control box 54 can be configured to transmit the data to the client terminal 58 in response to detection of an alarm condition based on the data received from at least one of the tools 52a, 52b, 52N, and/or the control box 54 can be configured to transmit the data to the client terminal 58 in response to a request for the data from the client terminal 58. The client terminal 58 can be configured to display the data received from the control box 54 on a user interface (not shown) for review by one or more users of the client terminal 58, such as a person overseeing an experiment involving the tools 52a, 52b, 52N, a lab assistant, a lab manager, a teacher in whose classroom the tools 52a, 52b, 52N are located, a student involved in performing an experiment involving the tools 52a, 52b, 52N, etc. A user of the client terminal 58 can thus be aware of conditions of the experiment involving the tools 52a, 52b, 52N even when located remotely therefrom.

The control box 54 can be configured to analyze the data received from the tools 52a, 52b, 52N and, based on the analysis, provide a recommendation that can be displayed on the client terminal 58. For example, the control box 54 can be configured to analyze days/times that a tool is used and suggest days/times that the tool will be used in the future. For another example, based on utilization data of an individual tool and of a fleet of tools including that tool, the control box 54 can be configured to determine any one or more of which tool(s) the site (e.g., the lab or the team using the tools) should buy more of (e.g., the current set of tools are being utilized a lot and will thus likely need replacement), determine which one or more of the tools should be retired (e.g., a subset of the current fleet of tools is not being used at all and should thus be retired), determine which one or more of the tools should be moved to another site or team (e.g., a subset of the tools is being underutilized by the team and can be moved to another team which is over utilizing similar tool(s), optimize service contracts associated with the tools (e.g., increase service contracts for overused equipment and decrease service contracts for underused equipment), calculate cost (pricing, payment, or billing) of using any of the tools based on a number of times the tool was used (as opposed to purchasing the tool itself). For yet another example, the control box 54 can be configured to compare real time data with stored historical data to determine an identity of an unknown material (e.g., compare optical data gathered in real time for an unknown material to stored optical properties of known materials to identify the unknown material). For another example, the control box 54 can be configured to compare reactants and desired product to a stored database of chemical reactions to identify a heating/stirring protocol for optimal yield and (in at least some embodiments) cause that protocol to be executed using the appropriate one or more of the available tools, optimize one or more parameters (e.g., stir rate, temperature, additional reagents, etc.) in accordance with real time data gathered for one or more self-optimizing parameters (e.g., optical density, pH, etc.) such as in a cell culture being performed in a shake flask or stir flask. For still another example, the control box 54 can be configured to determine optimal parameters to set a machine in order for a specific compound to be studied or purified from a sample such as in the case of an analytical experiment including high pressure liquid chromatography (HLPC), mass spectrometry, or the like. For yet another example, the control box 54 can be configured to determine from real time data adjustments to be made (e.g., temperature, stir rate, flow rate, solvents to mix, etc.) in real time (e.g., caused by the control box 54) to achieve a specific compound to be studied or purified from a sample. For another example, the control box 54 can be configured to facilitate tool calibration, such as in the case of a mass balance needing to be calibrated where a known mass is placed on the balance by a user and the control box 54 calibrates the reading on the balance to the correct value, or in the case of an optical spectrometer needing to be calibrated where wavelength or absorption of a known halogen light source, dark source, or reference source is used by the control box 54 to calibrate the optical spectrometer.

The control box 54 can be configured to detect an alarm condition based on data received from at least one of the tools 52a, 52b, 52N in a variety of ways. In at least some embodiments, the tools 52a, 52b, 52N can each be configured to transmit data indicative of at least one parameter measured by the tool and/or at least one parameter monitored by the tool. The control box 54, e.g., a processor thereof, can be configured to analyze the received data to determine whether the received data fails to satisfy predetermined criteria for the data so as to indicate some sort of error, e.g., a power failure, a parameter exceeding a tool's safe working range, energy usage/consumption above a preprogrammed maximum expected energy usage/consumption for the tool, a parameter exceeding a preprogramed upper limit for that parameter for this specific experiment, etc. If the received data indicates the presence of the error, so as to indicate an alarm condition, the control box 54 can be configured to automatically and immediately transmit information to the client terminal 58 indicative of the detected alarm condition, such as by causing a text message to be sent to the client terminal 58, by causing an email to be sent to user(s) associated with the client terminal 58, such as by causing a pop-up message to be displayed on a display of the client terminal 58, etc. A user of the client terminal 58 can thus be informed of any errors in real time with their detection, thereby allowing the user to address the error in any way the user sees fit, e.g., by contacting someone local to the tools 52a, 52b, 52N to correct or further investigate the alarm condition, by transmitting an instruction to the control box 54 to address the alarm condition, etc.

In at least some embodiments, at least one of the tools 52a, 52b, 52N can include a camera visualizing at least one other of the tools 52a, 52b, 52N. The camera can be configured to transmit gathered images of the visualized one or more of the tools 52a, 52b, 52N to the control box 54. The gathered images can be any type of images, as will be appreciated by a person skilled in the art, e.g., still images, video images, infrared images, etc. The control box 54 can be configured to analyze the received images for alarm conditions. For non-limiting example, the control box 54 can be configured to determine if received infrared images indicate that the visualized tool(s) and/or matter such as liquid contained within or otherwise associated with the visualized tool(s) have exceeded a certain predetermined maximum heat level, thereby indicating an alarm condition. For another non-limiting example, the control box 54 can be configured to determine if received infrared images indicate that the visualized tool(s) and/or matter such as liquid contained within or otherwise associated with the visualized tool(s) have moved out of the camera's frame, thereby indicating that the tool(s) and/or matter are in an improper location and hence indicating an alarm condition. For yet another non-limiting example, the control box 54 can be configured to determine from a video image and/or from a series of still images if the visualized tool(s) and/or matter such as liquid contained within or otherwise associated with the visualized tool(s) are moving below a certain predetermined maximum speed, thereby indicating an alarm condition. For still another non-limiting example, the control box 54 can be configured to determine if a visualized tool has unintentionally powered off by determining whether a power light of the visualized tool is off when it should be on, thereby indicating an alarm condition. The user of the client terminal 58 can view the camera's images transmitted to the client terminal 58, which can allow the user to inspect the images for alarm conditions and/or to generally view conditions of the experiment. For another non-limiting example, the control box 54 can be configured to determine from an image if liquid has spilled (e.g., liquid leaking from a pipe, liquid overflowing from a container, etc.), thereby indicating an alarm condition. The spill can be from any of the visualized tool(s) or from any non-visualized tool from which liquid has spilled into view.

In at least some embodiments, the control box 54 can be configured to automatically address an alarm condition without first receiving an instruction from the client terminal 58 to address the alarm condition, such as if a user does not have access to the client terminal 58 at the time the alarm condition is detected. The alarm condition's potential negative effects on the experiment can thus be minimized. The control box 54 can be configured to automatically address all alarm conditions or only certain types of alarm conditions, such as those pre-classified as emergencies. Non-limiting examples of emergency alarm conditions and responses thereto include a tool having its power off when it should be on such that the control box 54 attempts to turn the tool on (e.g., by instructing a switch located between the tool and a power source such as an electrical outlet to close, etc.), a liquid cooling below a certain predetermined minimum temperature so as to indicate approach of the liquid to its freezing temperature when freezing is undesired such that the control box 54 turns up the heat of a burner heating the liquid, detection of liquid boiling over its container such that the control box 54 turns off a hot plate heating the container and/or instructs a camera electronically connected thereto to take a photograph of the boiled-over container, etc. The control box 54 can be configured to transmit data to the client terminal 58 indicative of the alarm condition even if the control box 54 is configured to automatically address the alarm condition, which can help keep the user informed about the experiment and/or can allow the user to override the control box's automatic action responding to the alarm condition (e.g., allow the user to provide an instruction to the control box 54 reversing the control box's automatic action).

The client terminal 58 can be configured to allow the user(s) to provide instructions over the at least one communication line 60 to the control box 54, e.g., via user manipulation of the user interface, regarding one or more of the tools 52a, 52b, 52N. The instructions transmitted from the client terminal 58 can be related to monitoring of the tools 52a, 52b, 52N, which in general can include a request for information related to any one or more of the tools 52a, 52b, 52N, e.g., a request for data sensed or otherwise gathered by any one or more of the tools 52a, 52b, 52N, a request for a current status of any one or more of the tools 52a, 52b, 52N (e.g., a current temperature being sensed by one of the tools 52a, 52b, 52N, a current moving, still, infrared, etc. image being visualized by one of the tools 52a, 52b, 52N that includes a camera, an on/off status of any one of the tools 52a, 52b, 52N, etc.). The monitoring instructions can specify a particular one or more of the tools 52a, 52b, 52N about which the user would like information, thereby allowing the user to receive targeted information of current interest to the user. The instructions transmitted from the client terminal 58 can be related to controlling the tools 52a, 52b, 52N, which in general can include a request for one or more of the tools 52a, 52b, 52N to perform an action, such as any one or more of changing the tool's physical position, changing the tool's on/off state, and changing the tool's output. Non-limiting examples of changing the tool's output include changing how fast the tool is moving, changing how bright the tool's light is shining, increasing the tool's temperature (e.g., increasing a temperature of a hot plate), a camera zooming in to gather a tighter image, the tool (e.g., a liquid mixer, etc.) mixing at a slower rate, etc. The control instructions can specify a particular one or more of the tools 52a, 52b, 52N to perform an action, thereby allowing the user to control particular ones of the tools 52a, 52b, 52N. The control box 54 can be configured to execute the received instructions, thereby allowing for user monitoring and controlling the tools 52a, 52b, 52N even if the user is remotely located from the tools 52a, 52b, 52N, if the user cannot directly observe and/or directly manipulate any of the tools 52a, 52b, 52N (e.g., because the user is remotely located therefrom, the room in which the tools 52a, 52b, 52N are located is a sterile environment with limited human entrance, etc.), and/or if no personnel are on site with the tools 52a, 52b, 52N that the user can instruct to monitor and/or control the tools 52a, 52b, 52N when such monitoring and/or control is needed. The control instructions can be input to the client terminal 58 by the user for any reason, such as the user's desire to change experiment conditions based on the data received from the control box, the user following a pre-established experiment timeline, the user responding to an alarm condition, etc.

The instructions from the client terminal 58 to the control box 54 can be directed to one of the tools 52a, 52b, 52N, e.g., a monitoring instruction requesting information for the specific tool or a control instruction requesting that the specific tool perform one or more actions. The control box 54 can thus be configured to execute the instructions for that specific tool identified in the transmitted instructions from the client terminal 58. In at least some embodiments, the control box 54 can be configured to analyze instructions received from the client terminal 58 for a specific one of the tools 52a, 52b, 52N to determine whether the instructions, whether monitoring instructions or control instructions, trigger one or more actions for one or more others of the tools 52a, 52b, 52N. In this way, the control box 54 can help ensure that the client terminal 58 (and hence a user thereof) receives all information relevant to a monitoring request, can help ensure that the experiment maintains stability by not making changes to one tool that can adversely affect another tool, and/or can help reduce an amount of input that the user must provide to the client terminal 58 to effect certain actions in the experiment. The control box 54 can be preprogrammed with one or more algorithms to effect such analysis, such as by a recipe for the tools for which instructions are received from the client terminal indicating which one or more other tools can be affected by changes to that specific tool. Recipes are discussed further below. For non-limiting example, when the instructions cause the control box 54 to adjust a physical position of the specific tool, the control box 54 can be configured to adjust a field of view of a camera of one of the tools 52a, 52b, 52N that is visualizing the specific tool to ensure that the camera continues visualizing the specific tool.

Any of a variety of users can access, interact with, control, etc. a user interface from any of a variety of locations. For example, as shown in an embodiment illustrated in FIG. 2, the user interface can be accessible over a network 12 (e.g., over the Internet via cloud computing) from any number of client stations (also referred to herein as “client terminals”) 14 in any number of locations such as a laboratory facility 16 (e.g., a facility that has at least one lab onsite and/or manages at least one lab offsite, such as a hospital or other medical care center, a university or other school, a medical device company, a pharmaceutical company, etc.), a home base 18 (e.g., a scientist's home or office, a lab assistant's home or office, a lab manager's home or office, etc.), a mobile location 20, and so forth. The client station(s) 14 can access the system 10 through a wired and/or wireless connection to the network 12. In an exemplary embodiment, at least some of the client terminal(s) 14 can access the system 10 wirelessly, e.g., through Wi-Fi connection(s), which can facilitate accessibility of the system 10 from almost any location in the world. As shown in FIG. 2, the lab facility 16 includes client stations 14 in the form of a tablet and a computer touch screen, the home base 18 includes client stations 14 in the form of a mobile phone having a touch screen and a desktop computer, and the mobile location 20 includes client stations 14 in the form of a tablet and a mobile phone, but the lab facility 16, the home base 18, and the mobile location 20 can include any number and any type of client stations. In an exemplary embodiment, the system 10 can be accessible by a client terminal via a web address and/or a client application (generally referred to as an “app”).

It will be appreciated that the system 10 can include security features such that the aspects of the system 10 available to any particular user can be determined based on the identity of the user and/or the location from which the user is accessing the system. To that end, each user can have a unique username, password, and/or other security credentials to facilitate access to the system 10. The received security parameter information can be checked against a database of authorized users to determine whether the user is authorized and to what extent the user is permitted to interact with the system, view information stored in the system, and so forth. Exemplary, non-limiting examples of parties who can be permitted to access the system 10 include scientists, engineers, students, teachers, lab managers, lab equipment managers, and lab assistants.

The devices, systems, and methods disclosed herein can be implemented using one or more computer systems, also referred to as digital data processing systems and programmable systems. In general, a client terminal can include a computer system configured to facilitate data communication and data analysis.

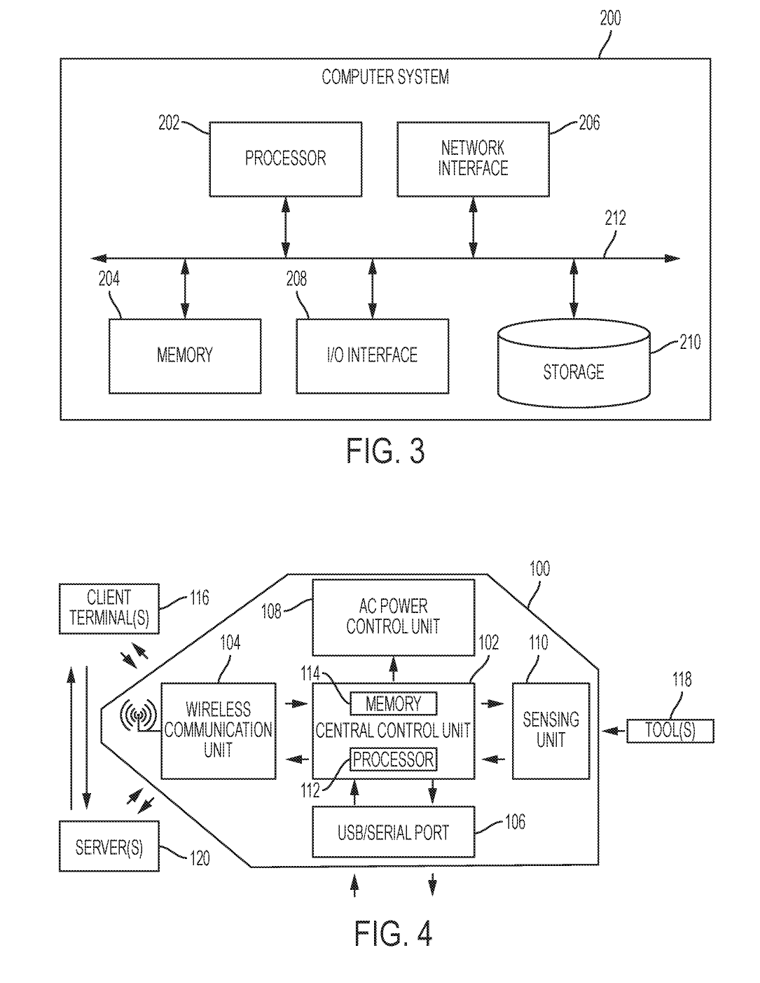

FIG. 3 illustrates one exemplary embodiment of a computer system 200. As shown, the computer system 200 can include one or more processors 202 which can control the operation of the computer system 200. The processor(s) 202 can include any type of microprocessor or central processing unit (CPU), including programmable general-purpose or special-purpose microprocessors and/or any one of a variety of proprietary or commercially available single or multi-processor systems. The computer system 200 can also include one or more memories 204, which can provide temporary storage for code to be executed by the processor(s) 202 or for data acquired from one or more users, storage devices, and/or databases. The memory 204 can include read-only memory (ROM), flash memory, one or more varieties of random access memory (RAM) (e.g., static RAM (SRAM), dynamic RAM (DRAM), or synchronous DRAM (SDRAM)), and/or a combination of memory technologies.

The various elements of the computer system 200 can be coupled to a bus system 212. The illustrated bus system 212 is an abstraction that represents any one or more separate physical busses, communication lines/interfaces, and/or multi-drop or point-to-point connections, connected by appropriate bridges, adapters, and/or controllers. The computer system 200 can also include one or more network interface(s) 206, one or more input/output (IO) interface(s) 208, and one or more storage device(s) 210.

The network interface(s) 206 can enable the computer system 200 to communicate with remote devices, e.g., other computer systems, over a network, and can be, for non-limiting example, remote desktop connection interfaces, Ethernet adapters, and/or other local area network (LAN) adapters. The IO interface(s) 208 can include one or more interface components to connect the computer system 200 with other electronic equipment. For non-limiting example, the IO interface(s) 208 can include high speed data ports, such as universal serial bus (USB) ports, 1394 ports, Wi-Fi, Bluetooth, etc. Additionally, the computer system 200 can be accessible to a human user, and thus the IO interface(s) 208 can include displays, speakers, keyboards, pointing devices, and/or various other video, audio, or alphanumeric interfaces. The storage device(s) 210 can include any conventional medium for storing data in a non-volatile and/or non-transient manner. The storage device(s) 210 can thus hold data and/or instructions in a persistent state, i.e., the value is retained despite interruption of power to the computer system 200. The storage device(s) 210 can include one or more hard disk drives, flash drives, USB drives, optical drives, various media cards, diskettes, compact discs, and/or any combination thereof and can be directly connected to the computer system 200 or remotely connected thereto, such as over a network. In an exemplary embodiment, the storage device(s) can include a tangible or non-transitory computer readable medium configured to store data, e.g., a hard disk drive, a flash drive, a USB drive, an optical drive, a media card, a diskette, a compact disc, etc.

The elements illustrated in FIG. 3 can be some or all of the elements of a single physical machine. In addition, not all of the illustrated elements need to be located on or in the same physical machine. Exemplary computer systems include conventional desktop computers, workstations, minicomputers, laptop computers, tablet computers, personal digital assistants (PDAs), mobile phones, and the like.

The computer system 200 can include a web browser for retrieving web pages or other markup language streams, presenting those pages and/or streams (visually, aurally, or otherwise), executing scripts, controls and other code on those pages/streams, accepting user input with respect to those pages/streams (e.g., for purposes of completing input fields), issuing Hypertext Transfer Protocol (HTTP) requests with respect to those pages/streams or otherwise (e.g., for submitting to a server information from the completed input fields), and so forth. The web pages or other markup language can be in Hypertext Markup Language (HTML) or other conventional forms, including embedded Extensible Markup Language (XML), scripts, controls, and so forth. The computer system 200 can also include a web server for generating and/or delivering the web pages to client computer systems.

In an exemplary embodiment, the computer system 200 can be provided as a single unit, e.g., as a single server, as a single tower, contained within a single housing, etc. The systems, devices, and methods disclosed herein can thus be provided as a singular unit configured to provide the various modules, display the various user interfaces, and capture the data described herein. The singular unit can be modular such that various aspects thereof can be swapped in and out as needed for, e.g., upgrade, replacement, maintenance, etc., without interrupting functionality of any other aspects of the system. The singular unit can thus also be scalable with the ability to be added to as additional modules and/or additional functionality of existing modules are desired and/or improved upon.

While some embodiments are described herein in the context of web pages, it will be appreciated that in other embodiments, one or more of the described functions can be performed without the use of web pages and/or by other than web browser software. A computer system can also include any of a variety of other software and/or hardware components, including by way of non-limiting example, operating systems and database management systems. Although an exemplary computer system is depicted and described herein, it will be appreciated that this is for sake of generality and convenience. In other embodiments, the computer system may differ in architecture and operation from that shown and described here.

One or more aspects or features of the subject matter described herein can be realized in digital electronic circuitry, integrated circuitry, specially designed application specific integrated circuits (ASICs), field programmable gate arrays (FPGAs) computer hardware, firmware, software, and/or combinations thereof. These various aspects or features can include implementation in one or more computer programs that are executable and/or interpretable on a programmable system including at least one programmable processor, which can be special or general purpose, coupled to receive data and instructions from, and to transmit data and instructions to, a storage system, at least one input device, and at least one output device. The programmable system or computing system may include clients and servers. A client and server are generally remote from each other and typically interact through a communication network. The relationship of client and server arises by virtue of computer programs running on the respective computers and having a client-server relationship to each other.

The computer programs, which can also be referred to as programs, software, software applications, applications, components, or code, include machine instructions for a programmable processor, and can be implemented in a high-level procedural language, an object-oriented programming language, a functional programming language, a logical programming language, and/or in assembly/machine language. As used herein, the term “machine-readable medium” refers to any computer program product, apparatus and/or device, such as for example magnetic discs, optical disks, memory, and Programmable Logic Devices (PLDs), used to provide machine instructions and/or data to a programmable processor, including a machine-readable medium that receives machine instructions as a machine-readable signal. The term “machine-readable signal” refers to any signal used to provide machine instructions and/or data to a programmable processor. The machine-readable medium can store such machine instructions non-transitorily, such as for example as would a non-transient solid-state memory or a magnetic hard drive or any equivalent storage medium. The machine-readable medium can alternatively or additionally store such machine instructions in a transient manner, such as for example as would a processor cache or other random access memory associated with one or more physical processor cores.

To provide for interaction with a user, one or more aspects or features of the subject matter described herein can be implemented on a computer having a display device, such as for example a cathode ray tube (CRT) or a liquid crystal display (LCD) or a light emitting diode (LED) monitor for displaying information to the user and a keyboard and a pointing device, e.g., a mouse, a trackball, etc., by which the user may provide input to the computer. Other kinds of devices can be used to provide for interaction with a user as well. For example, feedback provided to the user can be any form of sensory feedback, such as for example visual feedback, auditory feedback, or tactile feedback; and input from the user may be received in any form, including, but not limited to, acoustic, speech, or tactile input. Other possible input devices include, but are not limited to, touch screens or other touch-sensitive devices such as single or multi-point resistive or capacitive trackpads, voice recognition hardware and software, optical scanners, optical pointers, digital image capture devices and associated interpretation software, and the like.

Referring again to FIG. 1, the control box 54 can be configured as a standalone unit. The control box 54 can thus be configured to be easily integrated into a laboratory or other site of an experiment because it can be a singular piece of equipment. The control box 54 can include a housing (not shown) that houses all components of the control box 54 at least partially therein, thereby facilitating provision of the control box 54 as a standalone unit. In an exemplary embodiment, the housing can be waterproof, which can help prevent damage to components disposed within the housing. In an exemplary embodiment, the control box 54 can be portable, which can facilitate movement of the control box 54 between different experiment sites as experiments begin and end and/or can allow a single person to easily transport the control box 54.

As mentioned above, the control box 54 can be configured to electronically communicate with the server 62. The server 62 can be configured to provide cloud-based computing for the control box 54, as will be appreciated by a person skilled in the art. The control box 54 can thus have a smaller memory and/or a less powerful processor than may be needed for at least some data storage and/or data analysis to be performed on data received by the control box 54 because the server 62 can be configured to store data and/or analyze data when the storage and/or analysis is beyond or would unduly strain the capabilities of the control box 54. The control box 54 can thus be less expensive to manufacture and/or less expensive to purchase because the control box 54 can be configured to use resources of the server 62, which can be shared by a plurality of control boxes. In general, the server 62 can include a memory 66 configured to store data (e.g., historical data sensed by the tools 52a, 52b, 52N, time and date of alarm conditions detected by the control box, time and date of functions the control box 54 instructs various ones of the tools 52a, 52b, 52N to perform, amount of liquid or other consumable introduced into a particular tool, etc.) and can include a processor 68 configured to process data. Any or all of the analysis abilities of the control box 54 described herein can instead be performed by the server 62, e.g., by the processor 68 thereof, which can help offload processing burdens from the control box 54 and/or help reduce cost of the control box 54.

The server's memory 66 can be configured to store a plurality of recipes (also referred to as “documents” and “protocols”) each associated with one or more tools. Each of the recipes can be preprogrammed into the memory 66 so as to be available on demand, as discussed further below, when needed for a specific tool. In an exemplary embodiment, each of the recipes can be associated with a specific tool (e.g., a specific make and model of a tool). The recipe can thus be tailored to one tool so as to include information specific to that tool. In at least some embodiments, at least some of the recipes can be associated with a class of tools (e.g., hot plates, thermometers, etc.) so as to include information relevant to that class of tools.

In general, a recipe can include parameters relevant to the one or more tools associated with the recipe. The recipe can thus include information relevant to the tool(s), which can help the control box 54 more accurately and more efficiently monitor and control the tool(s). Each of the recipes stored in the memory 66 can include the same parameters, which can facilitate creation of new recipes (e.g., by an administrator of the system 50, by a provider of the server 62, etc.) and/or can facilitate the control box's use of recipes. Recipes can be configured to be created and edited via user interface, e.g., via a user interface on the client terminal 58, a server-side user interface, etc. Non-limiting examples of information that can be included in a recipe include tool model number, tool manufacturer name, class of the tool, number of inputs that the tool can receive, possible actions that the tool can perform, how the tool interacts with other tools, and operating limits of the tool. A non-limiting example of a recipe for a hot plate stirrer includes information regarding the model number, manufacturer name, maximum stir rate, default stir rate, stir rate increment amount, maximum temperature, default temperature, temperature increment amount, number of available inputs to the hot plate stirrer, and hot plate size.

The control box 54 can be configured to receive from the server 62 a recipe stored in the memory 66 for a specific tool connected to the control box 54. In an exemplary embodiment, the electronic connection of a tool to the control box 54 (e.g., the first tool 52a being electronically connected to the control box 54 by physical or wireless communication line 56, the second tool 52b being electronically connected to the control box 54 by physical or wireless communication line 56, etc.) can trigger receipt of the recipe from the server 62. In at least some embodiments, the server 62 can be configured to automatically detect electronic connection of a tool to the control box 54 and to automatically transmit the recipe(s) for that newly connected tool to the control box 54. In at least some embodiments, the control box 54 can be configured to request a recipe from the server 62 in response to electronic connection of a tool to the control box 54. This can result in slightly slower receipt of the recipe at the control box 54 than with automatic transmission of the recipe from the server 62, but it can use less network resources and/or less use of server 62 and/or control box 54 resources than automatic detection and transmission. The control box 54 can be configured to only automatically receive recipes from the server 62, the control box 54 can be configured to always request recipes from the server 62, or the control box 54 can be configured to automatically receive some recipes from the server 62 and to request some recipes from the server 62 according to certain predetermined criteria. The certain predetermined criteria can include, e.g., automatic receipt of recipes for certain classes of tools and request of recipes for other classes of tools.

The control box 54 can be configured to query the server 62 in response to a tool being electronically connected thereto, e.g., in response to the first tool 52a being electronically connected to the control box 54 by physical or wireless communication line 56, in response to the second tool 52b being electronically connected to the control box 54 by physical or wireless communication line 56, etc. In particular, the control box 54 can be configured to transmit a request to the server 62 for a recipe associated with the newly connected tool. The request can include information identifying the newly connected tool to the server 62, e.g., information indicating the tool's specific make and model and/or information indicating the tool's class. The server 62 can be configured to, in the case of each of the recipes being associated with a single tool, retrieve from its memory 66 the one recipe associated with the newly connected tool, and, in the case of at least some of the recipes being associated with a class of tools, retrieve from its memory 66 the one recipe associated with the newly connected tool's class. The server 62 can thus be configured to retrieve one or two recipes from its memory 66 in response to the request from the control box 54. The server 62 can be configured to transmit the retrieved recipe(s) to the control box 54 over the at least one communication line 64. The control box 54 can be configured to store the received recipe(s) in a memory (not shown) of the control box 54. The control box 54 can thus be configured to locally store the recipe(s) for the newly connected tool, which can allow the control box 54 to process data (e.g., with a processor (not shown)) of the control box 54) using the recipe without having to retrieve the recipe from the server 62 each time the recipe is needed. Because the control box 54 can be configured to receive recipes from the server 62 for each of the tools 52a, 52b, 52N connected to the control box 54, the control box 54 can be configured to locally store all recipes needed to process data received from the various tools 52a, 52b, 52N, which can conserve network resources and/or can allow data to be processed more quickly.

A recipe can include one or more pre-set procedures for the tool(s) associated with the recipe. The pre-set procedures can allow the control box 54 to initialize the tool(s) associated therewith by instructing the tool(s) to achieve the parameters defined in the pre-set procedure(s), such as heating to a predetermined initial temperature, adding a certain amount of liquid to a container, etc. The pre-set procedure(s) can include a single instruction, such as heating to a certain temperature, a plurality of instructions that can be performed simultaneously, and/or a plurality of instructions that must be performed in sequence with execution of one instruction triggering the next instruction in the sequence (e.g., heat a hot plate to a certain temperature and then add a certain amount of liquid to a container on the hot plate).

The server 62 will typically include at least one pre-stored recipe for each of the tools 52a, 52b, 52N connected to the control box 54 such that the control box 54 can receive from the server 62 at least one recipe for each of the tools 52a, 52b, 52N connected thereto. It is possible, however, that the server 62 will not include a recipe for a tool electronically connected to the control box 54, e.g., if the tool is sufficiently new. If the server 62 does not have a recipe available for a newly connected tool, when the server 62 is configured to automatically transmit a recipe to the control box 54 for the newly connected tool, the server 62 can instead of transmitting a recipe to the control box 54 transmit an indication to the control box 54 that no recipe is available for the newly connected tool. The control box 54 can, in response, be configured to prompt a user to create a recipe for the tool, e.g., provide a recipe template on a user interface at the client terminal 58 that a user can complete as much as possible. The control box 54 can be configured to receive from the client terminal 58 the recipe for the tool as created by the user and store the recipe in the control box's memory. The control box 54 can also be configured to transmit the new recipe to the server 62 for storage in the server's memory 66 so the recipe is available for any subsequent electronic connections of the tool to the control box 54 or to another control box in electronic communication with the server 62. If in response to control box 54 request for a newly connected tool's recipe the server 62 does not have a recipe available for the newly connected tool, the server 62 can be configured to transmit an indication to the control box 54 that no recipe is available for the newly connected tool, which can cause the control box 54 to prompt for a recipe as discussed above.

The recipes will typically be accurate so as to not require editing, but the recipes can be configured to be edited by a user. The editing can allow for correction of inadvertent data entry errors and/or can allow a user to set specific parameters for the tool in view of a specific experiment (e.g., set a certain maximum temperature of a tool that is less than the tool's standard maximum temperature as reflected in the recipe to prevent that tool from rising above the certain temperature during the experiment, etc.). The user interface at the client terminal 58 can be configured to include a prompt allowing user editing of a recipe for any of the tools 52a, 52b, 52N, e.g., include a listing of the tools 52a, 52b, 52N with a clickable icon next to each allowing recipe editing for that tool, include a clickable icon for “recipe editing” that upon access thereof prompts the user to select a tool for recipe editing, prompt the user upon electronic connection of a new tool to the control box 54 asking whether the user would like to view and edit the recipe for that newly connected tool, etc. In at least some embodiments, editing or recipes can be restricted to specific users and/or users with specific authorization credentials, which can help maintain accuracy of recipes.

FIG. 4 illustrates another embodiment of a system configured to facilitate monitoring and controlling one or more tools 118. In this illustrated embodiment, the system includes a control box 100 that includes at least partially disposed within a housing (not shown) thereof a central control unit 102, a wireless communication unit 104, a USB/serial port 106, an AC power control unit 108, and a sensing unit 110. As in this illustrated embodiment the central control unit 102 can include a processor 112 and a memory 114. In an exemplary embodiment, the central control unit 102 and the wireless communication unit 104 can be fully disposed within the housing, which can help protect the central control unit 102 and the wireless communication unit 104 from being damaged, and the USB/serial port 106, the AC power control unit 108, and the sensing unit 110 can be partially disposed within the housing, which can allow the USB/serial port 106, the AC power control unit 108, and the sensing unit 110 to be physically accessible from outside the housing, which can allow physical connection of external component(s) thereto. The control box 100 can include a heat sink (not shown) mounted on the housing, which can help cool the control box 100 and/or help ensure a stable temperature inside the control box 100, e.g., an interior of the control box 100 that has components fully or partially disposed therein, and thereby help prevent any of the control box's components from overheating and failing. The control box 100 can include more components than those illustrated (e.g., include one or more additional USB/serial ports, one or more additional sensing units, one or more additional memories, one or more additional processors, an indicator light such as an LED, a display, etc.) or fewer components than those illustrated.

As in this illustrated embodiment, the system can include one or more client terminals 116 and can include one or more servers 120 configured to wirelessly communicate with the control box 100 via the wireless communication unit 104. The one or more client terminals 116 can be configured to directly wirelessly communicate with the control box 100 via the wireless communication unit 104 and/or indirectly wirelessly communicate with the control box 100 via the sever(s) 120 configured to wirelessly communicate with the control box 100 via the wireless communication unit 104.

The central control unit 102 can have a variety of sizes, shapes, and configurations. In general, the central control unit 102 can be configured to facilitate data transmission from the control box 100, data receipt at the control box 100, data analysis at the control box 100, and control of other components of the control box 100 (e.g., control of the wireless communication unit 104, the USB/serial port 106, the AC power control unit 108, and the sensing unit 110).

The wireless communication unit 104 can have a variety of sizes, shapes, and configurations. In general, the wireless communication unit 104 can include one or more components (e.g., router, etc.) configured to facilitate electronic communication, similar to that discussed above regarding the network interface 32.

The USB/serial port 106 can have a variety of sizes, shapes, and configurations. In general, the USB/serial port 106 can be configured to physically connect one or more external devices to the control box 100, such as IO devices, flash memory drives, etc. Although this illustrated embodiment includes an 10 interface in the form of the USB/serial port 106, control boxes can include USB/serial port(s) in addition to or instead of other types of 10 interfaces. The USB/serial port 106 can be configured as an interface between the device(s) connected thereto and the central control unit 102 such that data can be transferred between the connected device(s) and the central control unit 102.

The AC power control unit 108 can have a variety of sizes, shapes, and configurations. In general, the AC power control unit 108 can be configured to connect the control box 100 to a source of AC power, e.g., an electrical outlet. In some embodiments, the control box 100 can have an on-board power source, e.g., one or more batteries, etc., and can either optionally use an AC power source or not be configured to connect to AC power. Connecting to AC power can help the control box 100 have predictable power.

The sensing unit 110 can have a variety of sizes, shapes, and configurations. In general, the sensing unit 110 can be configured to interface with the tool(s) 118 and receive data therefrom, e.g., data gathered by the tool(s) 118 via sensor(s), etc. The sensing unit 110 can be configured as an interface between the tool(s) 118 connected thereto and the central control unit 102 such that data can be transferred between the connected tool(s) 118 and the central control unit 102. The sensing unit 110 can be configured to convert the sensed data from the tool(s) to numerical data that can be more easily processed by the control box 100, as will be appreciated by a person skilled in the art.

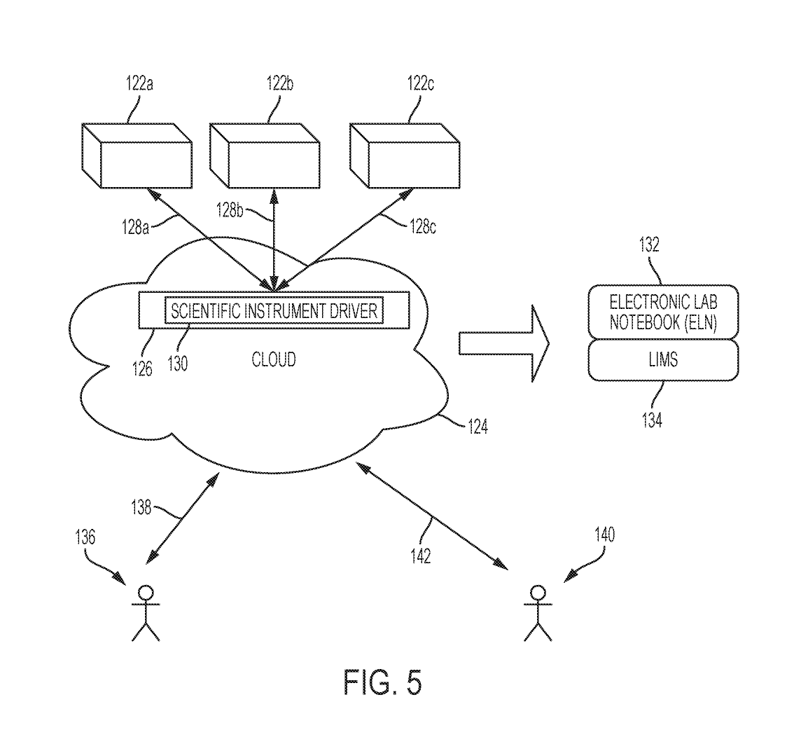

FIG. 5 illustrates another embodiment of a system configured to facilitate monitoring and controlling one or more tools 122a, 122b, 122c. The system includes three tools 122a, 122b, 122c, but the system can include another number of tools, as discussed herein. In general, the system is configured as a cloud-based platform for monitoring and controlling the one or more tools 122a, 122b, 122c. Providing a cloud-based platform may be more reliable than using a control box alone to monitor and control one or more tools since the cloud system will typically have redundant power sources, can be upgraded to affect multiple sites instead of individually upgrading control boxes at each of the sites, can be more easily upgraded than the control box, and/or can allow data to be collected across multiple experiments to facilitate learning (e.g., of optimal conditions, of common alarm conditions, of response time to address alarm conditions, etc.) from all of the experiments.

In this illustrated embodiment, the system includes a cloud 124 having a cloud-based server 126 configured to electronically communicate with the one or more tools 122a, 122b, 122c along at least one communication line 128a, 128b, 128c, which are each wireless in this illustrated embodiment but can be wired. The server 126 can generally be configured and used similar to the server 62 discussed above. The server 126 in this illustrated embodiment can be configured to provide cloud-based computing for the one or more tools 122a, 122b, 122c. In this way, as mentioned above, a control box need not be present since the server 126 can provide the analysis abilities of the control box as described herein. The server 126 can include a driver 130 to facilitate the processing of data regarding the one or more tools 122a, 122b, 122c, which are each scientific instruments in this illustrated embodiment such that the driver 130 is a scientific instrument driver.

The server 126 can be configured to electronically communicate with at least one electronic lab notebook (ELN) 132. The server 126 can be configured to receive data from the one or more tools 122a, 122b, 122c indicative of one or more parameters related to each of the one or more tools 122a, 122b, 122c, e.g., model number, manufacturer name, energy usage/consumption, tool location (e.g., based on RFID, Bluetooth, or iBeacon communication technology), tool owner, tool asset tag number, user manual for a tool, date of last servicing, date of last calibration, date of last validation, data of last qualification, service representative (for any of servicing, calibration, validation, and qualification), user of a tool (e.g., based on Bluetooth or iBeacon communication with a device associated with a user in effective proximity of the tool) maximum stir rate, default stir rate, stir rate increment amount, maximum temperature, default temperature, current temperature (time and date stamped), temperature increment amount, number of available inputs, and size. The data can be uniquely associated with one of the tools 122a, 122b, 122c (e.g., a current operating temperature of one of the tools 122a, 122b, 122c, model number of one of the tools 122a, 122b, 122c, energy usage/consumption of one of the tools 122a, 122b, 122c, day/time one of the tools 122a, 122b, 122c was used, length of time one of the tools 122a, 122b, 122c is used, days/times one of the tools 122a, 122b, 122c was used most, a percentage of utilization for one of the tools 122a, 122b, 122c, an average usage of one of the tools 122a, 122b, 122c, etc.), and/or the data can be aggregated data of a similar type for multiple ones of the tools 122a, 122b, 122c (e.g., a total energy usage/consumption of the tools 122a, 122b, 122c, a number of experiments or runs performed using the tools 122a, 122b, 122c, a total number of duty hours of the tools 122a, 122b, 122c, a total number of idle hours of the tools 122a, 122b, 122c, usage of the tools 122a, 122b, 122c based on tool type (e.g., plate reader versus autosampler), usage of the tools 122a, 122b, 122c aggregated based on brand, usage of the tools 122a, 122b, 122c aggregated based on tool age, etc.). The server 126 can be configured to communicate the data received from the one or more tools 122a, 122b, 122c to the ELN 132 for recording therein. The server 126 can be configured to automatically communicate this data to the ELN 132, which can be configured to automatically store the data received from the server 126. The ELN 132 can thus be configured to be automatically updated with information regarding the one or more tools 122a, 122b, 122c and hence regarding the scientific experiment being performed using the one or more tools 122a, 122b, 122c. Automatic updating of the ELN 132 may help prevent data entry errors since a user need not manually input the data to the ELN 132, may help the ELN 132 include complete information, may help a user track and/or identify alarm conditions, and/or may help the ELN 132 include up-to-date information.

The server 126 can be configured to communicate the data to the ELN 132 in real time with receipt of the data from any of the one or more tools 122a, 122b, 122c, which may help ensure that the ELN 132 includes the most recent information related to the one or more tools 122a, 122b, 122c. Alternatively, the server 126 can be configured to communicate the data to the ELN 132 according to a predetermined schedule (e.g., every minute, hourly, daily, etc.) for any or all of the tools one or more tools 122a, 122b, 122c (with the same predetermined schedule being used for data related to each of the tools one or more tools 122a, 122b, 122c or different predetermined schedules being used for data related to different ones of the tools one or more tools 122a, 122b, 122c). Communicating data to the ELN 132 according to a predetermined schedule may help conserve and manage system resources.

The server 126 can be configured to electronically communicate with at least one laboratory information management system (LIMS) 134. The server 126 can be configured to receive data from the one or more tools 122a, 122b, 122c indicative of one or more parameters related to each of the one or more tools 122a, 122b, 122c, as mentioned above. The server 126 can be configured to communicate the data received from the one or more tools 122a, 122b, 122c to the LIMS 134 for recording therein. The server 126 can be configured to automatically communicate this data to the LIMS 134, which can be configured to automatically store the data received from the server 126. The LIMS 134 can thus be configured to be automatically updated with information regarding the one or more tools 122a, 122b, 122c and hence regarding the scientific experiment being performed using the one or more tools 122a, 122b, 122c. Automatic updating of the LIMS 134 may help prevent data entry errors since a user need not manually input the data to the LIMS 134, may help the LIMS 134 include complete information, may help a user track and/or identify alarm conditions, and/or may help the LIMS 134 include up-to-date information.

The server 126 can be configured to communicate the data to the LIMS 134 in real time with receipt of the data from any of the one or more tools 122a, 122b, 122c, which may help ensure that the LIMS 134 includes the most recent information related to the one or more tools 122a, 122b, 122c. Alternatively, the server 126 can be configured to communicate the data to the LIMS 134 according to a predetermined schedule (e.g., every minute, hourly, daily, etc.) for any or all of the tools one or more tools 122a, 122b, 122c (with the same predetermined schedule being used for data related to each of the tools one or more tools 122a, 122b, 122c or different predetermined schedules being used for data related to different ones of the tools one or more tools 122a, 122b, 122c). Communicating data to the LIMS 134 according to a predetermined schedule may help conserve and manage system resources.

The server 126 can be configured to electronically communicate with a first user 136, e.g., along at least one communication line 138 with a client terminal associated with the first user 136, to facilitate development of the driver 130 and/or of other software aspects of the server 126 to facilitate monitoring and controlling of the one or more tools 122a, 122b, 122c. For non-limiting example, if a recipe for one of the tools 122a, 122b, 122c is not stored in the server's memory, the first user 136 can contribute, via a user interface or app at the client terminal, a recipe for the tool. For another non-limiting example, the first user 136 can edit a recipe for one of the tools 122a, 122b, 122c, via a user interface or app at the client terminal. For yet another non-limiting example, the first user 136 can edit an appearance of a user interface at the client terminal to customize the user interface according to the first user's preferences, such as colors, arrangement of windows on the user interface, choosing what data to display for particular ones of the one of the tools 122a, 122b, 122c, etc. For still another non-limiting example, the first user can specify a predetermined schedule with which to update the ELN 132 and/or a predetermined schedule with which to update the LIMS 134.

The server 126 can be configured to electronically communicate with a second user 140, e.g., along at least one communication line 142 with a client terminal associated with the second user 140, to facilitate monitoring and controlling of the one or more tools 122a, 122b, 122c during the course of a scientific experiment. Similar to that discussed above regarding the control box 54, the server 126 can be configured to transmit data regarding the one or more tools 122a, 122b, 122c to the second user's client terminal on a predetermined schedule (e.g., hourly, daily, etc.) for any or all of the one or more tools 122a, 122b, 122c (with the same predetermined schedule being used for all the tools 122a, 122b, 122c or different predetermined schedules being used for different ones of the tools 122a, 122b, 122c), the server 126 can be configured to transmit the data to the second user's client terminal in response to detection of an alarm condition based on the data received from at least one of the tools 122a, 122b, 122c, and/or the server 126 can be configured to transmit the data to the second user's client terminal in response to a request for the data from the second user's client terminal. The data can be uniquely associated with one of the tools 122a, 122b, 122c, and/or the data can be aggregated data of a similar type for multiple ones of the tools Similar to that discussed above regarding the client terminal 58, the second user's client terminal can be configured to display the data received from the server 126 on a user interface for review by the second user 140. The second user 140 can thus be aware of conditions of the experiment involving the one or more tools 122a, 122b, 122c even when located remotely therefrom. The first and second users 136, 140 are shown as different people in this illustrated embodiment, but the same user can communicate with the server 126 via a client terminal to facilitate development of the driver 130 and/or of other software aspects of the server 126 and to facilitate monitoring and controlling of the one or more tools 122a, 122b, 122c during the course of a scientific experiment.

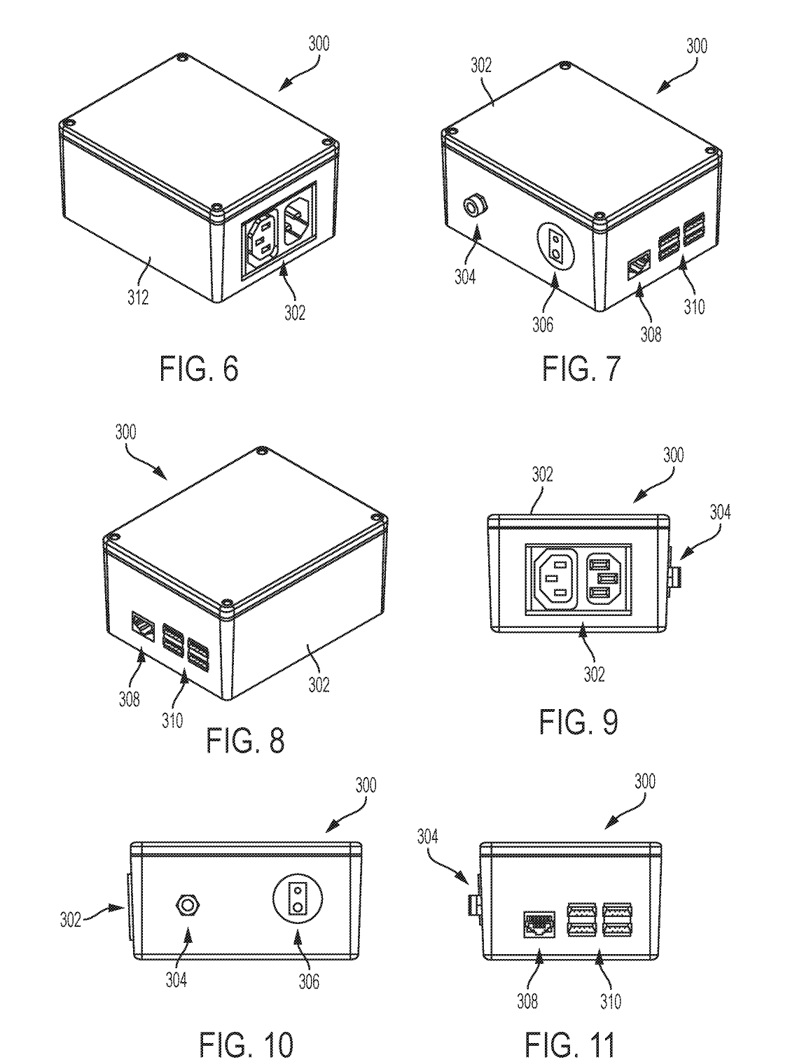

FIGS. 6-11 illustrate an embodiment of a control box 300 configured to facilitate monitoring and controlling one or more tools (not shown) electronically connected thereto. As in this illustrated embodiment, the control box 300 can include an AC inlet/outlet 302 for power control, a DC power input 304, a tool outlet 306 (in this illustrated embodiment, a thermocouple probe output configured to connect to a thermocouple), a network port 308 (an Ethernet port in this illustrated embodiment), an IO interface 310 (four USB ports in this illustrated embodiment), a wireless communication unit (not shown), and a central control unit (not shown). The control box 300 can include a housing 312 that at least partially houses the AC inlet/outlet 302, the DC power input 304, the tool outlet 306, the network port 308, the IO interface 310, the wireless communication unit, and the central control unit therein. As in this illustrated embodiment, the AC inlet/outlet 302, the DC power input 304, the tool outlet 306, the network port 308, and the IO interface 310 can be partially disposed within the housing 312, and the wireless communication unit and the central control unit can be fully disposed within the housing 312. As in this illustrated embodiment, the housing 312 can be waterproof. The control box 300 can include a heat sink (not shown) mounted on the housing 312, which can help cool the control box 300. The control box 300 can include more components than those illustrated (e.g., include one or more additional tool outlets, one or more additional IO interfaces, an indicator light such as an LED, a display, etc.) or fewer components than those illustrated (e.g., not include the AC inlet/outlet 302, not include the thermocouple probe output 306, include less than four USB ports 310, etc.).

As mentioned above, any of a variety of users can access, interact with, control, etc. a user interface, with the user interface optionally being customized for a category of a particular user, such as any one or more of a leader of an experiment involving tool(s) being controlled and monitored, a lab manager overseeing a plurality of different experiments involving different scientific teams, an assistant assisting one or more others in performing an experiment, and an administrator of a system configured to provide the user interface. The user interface can provide data regarding any one or more aspects of a system including a control box configured to electronically connect with one or more tools. In addition to providing data to a user, the user interface can be configured to accept user input, e.g., via an I/O device, and data input by the user can be stored in any one or more memories. For non-limiting example, the user interface can be configured to prompt a user to enter data in response to a question regarding whether the user would like current sensed data from a tool electronically connected to a control box. For another non-limiting example, the user interface can be configured to allow a user to request a change of a setting of a tool electronically connected to a control box. For yet another non-limiting example, the user interface can be configured to allow a user to edit a recipe, e.g., via a fillable form, for a tool electronically connected to a control box.

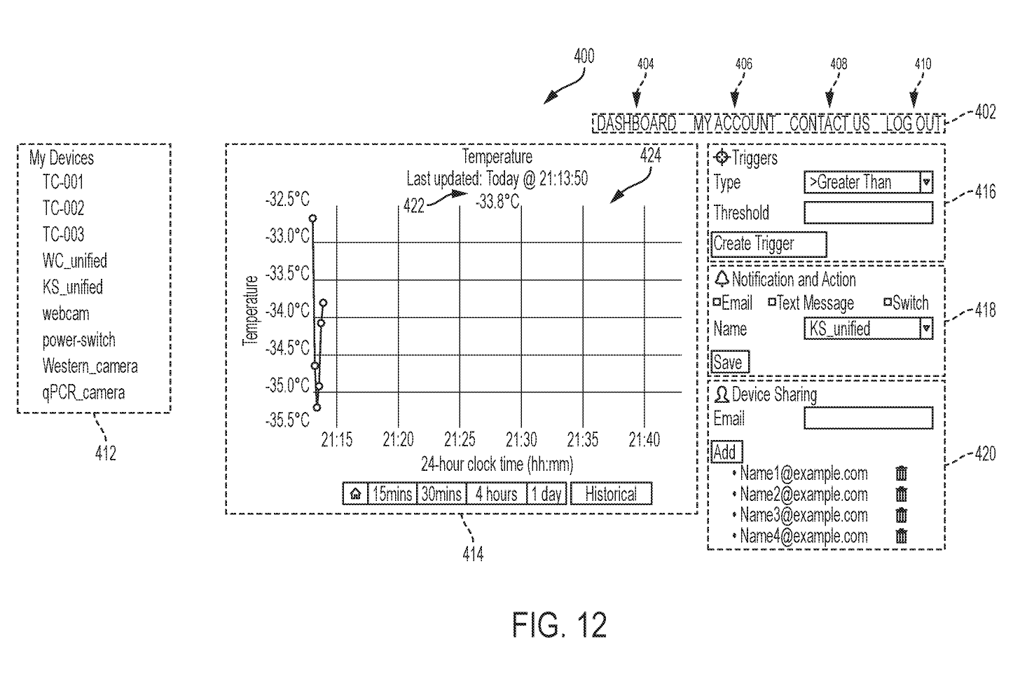

FIG. 12 illustrates one embodiment of a user interface 400 configured to be manipulated by a user and configured to be displayed on a client terminal (not shown) in electronic communication with a control box (not shown) in electronic communication with one or more tools (not shown). The user interface 400 can include a menu 402 identifying screens that the user can choose to access, e.g., by clicking on an item in the menu 402. As in this illustrated embodiment, the menu 402 can include choices for Dashboard 404 configured to provide a dashboard including an overview of the experiment being controlled by the control box, My Account 406 configured to provide information regarding the user's account with the system that includes the control box, Contact Us 408 configured to provide the user with access to help with the system and/or to provide feedback on the system, and Log Out 410 configured to log the user out of the system. The user interface 400 in this illustrated embodiment shows the dashboard that can be displayed to the user upon selection of the Dashboard 404 in the menu 402.

As in this illustrated embodiment, the dashboard can include one or more windows of information related to the experiment associated with the user. As in this illustrated embodiment, the windows shown on the dashboard can include a devices window 412, a parameters window 414, a triggers window 416, a notification and action window 418, and a device sharing window 420. The system can be configured to allow the user to customize the dashboard, such as allowing the user to select which of the windows 412, 414, 416, 418, 420 to show by default on the dashboard. Each of the windows 412, 414, 416, 418, 420 can have a variety of configurations.

The devices window 412 can identify the one or more tools electronically connected to the control box. In this illustrated embodiment, the tools include three thermocouples (identified as TC-001, TC-002, and TC-003), three cameras (a webcam, a camera visualizing a west side of the experiment space, and a qPCR camera), and other tools give user-identified names of WC unified and KS unified. A user's selection of any of the identified tools, e.g., touching the tool's name on a touchscreen, clicking on the tool's name using a mouse, etc., can cause information related to that tool to be displayed in the parameters window 414. Data input into the triggers window 416, the notification and action window 418, and/or the device sharing window 420 while that tool is selected can allow the input data to be associated with that tool.

The parameters window 414 can provide parameter data for the tool selected in the devices window 412. In this illustrated embodiment, temperature information is provided for one of the thermocouples, but one or more other parameters can be shown in addition to or in alternative to temperature, depending on the tool selected. As in this illustrated embodiment, the parameters information can include a current value 422 of the parameter. The parameters window 414 can thus provide real time data for the parameter. The current value 422 can be based on a last measured/monitored value for the parameter, which, as will be appreciated by a person skilled the art, may not be precisely the parameter's current value due to time elapsed since the value 422 was measured/monitored but nevertheless be considered to be the parameter's current value. As in this illustrated embodiment, the parameters information can be presented in a time series graph 424 for the past “X” amount of time prior to the current time. The parameters window 414 can be configured to allow the user to select a range of time for which the parameter information is shown, e.g., the past 15 minutes, the past 30 minutes, the past 4 hours, the past day, historical information older than one day old, etc. The graph 424 can include the current value 422 so as to provide fully up-to-date data for the parameter. The tool in this illustrated embodiment only has one parameters (temperature) associated therewith, but a tool can have a plurality of parameters associated therewith. If a tool has multiple parameters associated therewith, e.g., temperature and stir rate, light brightness and temperature, weight and volume, etc., the parameters window 414 can be configured to simultaneously show data for all of the parameters, or the parameters window 414 can be configured to show data for only one of the parameters at a time and be configured to allow the user to select which of the parameters is currently shown. In at least some embodiments, the parameters window 414 can be configured to allow the user to select how many of the multiple parameters are shown therein at once for that tool and/or which one or more of the multiple parameters should be shown by default in the parameters window 414 for that tool.

The triggers window 416 can allow the user to set triggers for any of the tools that cause the control box to identify an alarm condition when the trigger is met (e.g., when the control box receives data from one of the tools and determines that received data meets the trigger criteria pre-set by the user). The triggers window 416 can allow the user to select a type of the trigger, e.g., using a drop-down menu as in this illustrated embodiment, and to indicate a threshold value for the trigger, e.g., by entering text in a text box. The trigger types can include, as in this illustrated embodiment, “greater than” for a trigger when a data value is greater than the entered threshold value, “greater than or equal to” for a trigger when a data value is greater than or equal to the entered threshold value, “less than” for a trigger when a data value is less than the entered threshold value, “less than or equal to” for a trigger when a data value is less than or equal to the entered threshold value, and “equal to” for a trigger when a data value is equal to the entered threshold value. As in this illustrated embodiment, multiple triggers can be set for the same parameter, and multiple triggers can be set for the same tool.

The notification and action window 418 can allow the user to select a tool and how notifications regarding that tool should be provided to the user, e.g., how alarm conditions should be communicated to the user when a preset trigger is met, etc. As in this illustrated embodiment, the notifications can be provided by email or text message. The notification and action window 418 can allow the user to activate a power switch turning power on or off when an alarm condition is met, e.g. if a temperature measured by a thermocouple is above a threshold set in the triggers window 416 then the user can switch the power off for an instrument associated with the thermocouple, e.g., an instrument that the thermocouple is sensing a process thereof. The power switch activation in this illustrated embodiment includes a selectable “Switch” button but can be provided in other ways, as will be appreciated by a person skilled in the art, such as a toggle, a checkable/uncheckable box, etc. Other non-limiting examples of notification methods include telephone calls, pages, audio played at a client terminal, and multimedia messages.

The device sharing window 420 can identify other users of the system who can access the experiment's information through the system. In at least some embodiments, the device sharing window 420 can be available to only certain users, e.g., users with administrative access to the system, which can help prevent unauthorized users from access experiment data. Four users are shown in this illustrated embodiment. The number of users who can be given access to the system can be limited to a predetermined number, or an unlimited number of users can be given access to the system.

The user interface 400 in the illustrated embodiment of FIG. 12 is optimized for display on a client terminal with a relatively large display, e.g., a laptop computer, a desktop computer, a tablet, etc. For smaller displays, such as those of mobile phones, PDAs, etc., fewer of the windows 412, 414, 416, 418, 420 can be displayed at a time, information provided in various ones of the windows 412, 414, 416, 418, 420 can be displayed in different ways to conserve space, and/or the menu 402 can be provided in a different way to conserve space.

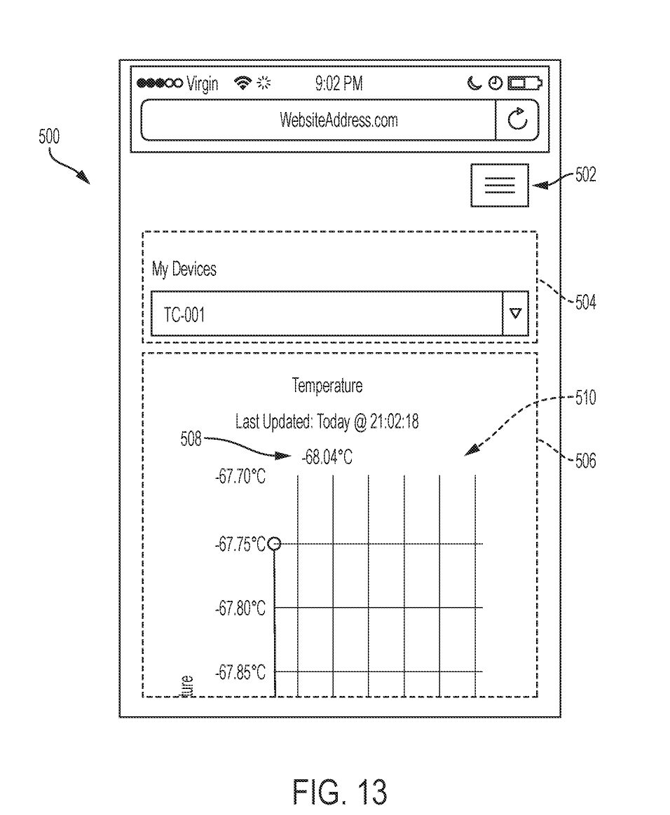

FIG. 13 illustrates another embodiment of a user interface 500 configured to be manipulated by a user and configured to be displayed on a client terminal (not shown) in electronic communication with the control box of the embodiment of FIG. 12. The user interface 500 in this illustrated embodiment is optimized for display on a client terminal with a relatively small display, a mobile phone in this illustrated embodiment. The user interface 500 can generally be configured to display the same information as the user interface 400 of FIG. 12, e.g., the same windows, but less information may be shown on the screen at any given time in the embodiment of FIG. 13 due to the display's smaller size. As in this illustrated embodiment, the user interface 500 can include a menu 502, a devices window 504 that allows selection of tools via drop-down menu, and a parameters window 506 including a current value 508 of the displayed parameter and a time series graph 510 plotting the parameter over the past “X” amount of time. Selection of different items in the menu 502 can allow different windows to be shown on the display, can provide access to other aspects of the system (e.g., account settings, help, etc.), and can allow the user to log out of the system.

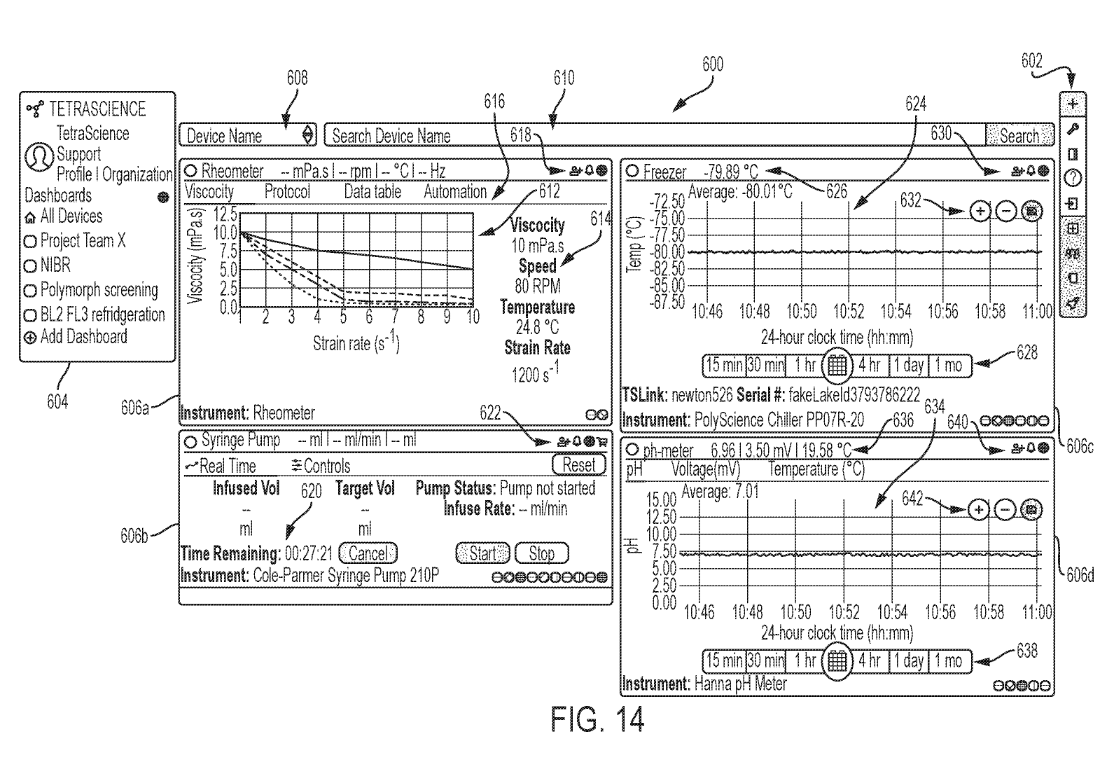

FIG. 14 illustrates another embodiment of a user interface 600 configured to be manipulated by a user and configured to be displayed on a client terminal (not shown) in electronic communication with a control box (not shown) in electronic communication with one or more tools (not shown). The user interface 600 can generally be configured and used similar to the user interface 400 of FIG. 12. As in this illustrated embodiment, the user interface 600 can include a menu 602, an experiments window 604 identifying and allowing selection of each experiment associated with a user of the user interface 600 (e.g., the user currently logged into the system to access the user interface 600), and parameters windows 606a, 606b, 606c, 606d for each of the tools associated with the currently selected one of the experiments associated with the user. The user interface 600 can also allow selection of search criteria via drop-down menu 608, e.g., search by device name, user name, device identification number, etc. The user interface 600 can provide a search function 610 (e.g., a search bar into which text can be typed) that allows the user to search for a particular tool by name to allow that tool's parameter window to be shown on the user interface 600.

The parameters windows 606a, 606b, 606c, 606d can provide parameter data for their respective tools, which in this illustrated embodiment include a rheometer, a syringe pump, a freezer, and a pH-meter. The data shown in each of the parameters windows 606a, 606b, 606c, 606d can be customized for the particular tool associated therewith to allow for the most relevant information for that tool to be shown to the user. As discussed herein, the user interface 600 can be customized by a user, which may allow the user to customize the data shown in each of the parameters windows 606a, 606b, 606c, 606d.

The rheometer parameters window 606a shows viscosity information including a graph 612 of viscosity versus strain rate and current values 614 of viscosity, speed, temperature, and strain rate. Viscosity information is currently selected in a selection menu 616, but other information related to the rheometer can be selected by the user for display, including protocol information, data table information, and automation information. The rheometer parameters window 606a can include a menu 618 allowing the user to add additional users that can access data for the rheometer, to access alarm condition information for the rheometer, and to adjust settings for the rheometer.

The syringe pump parameters window 606b shows real time information for the syringe pump. In this illustrated embodiment the syringe pump has not yet been started, so no real time data values are shown for the syringe pump. The syringe pump parameters window 606b can include a timer 620 indicating a time remaining until the syringe pump starts. The syringe pump parameters window 606b can include a menu 622 allowing the user to add additional users that can access data for the syringe pump, to access alarm condition information for the syringe pump, to adjust settings for the syringe pump, and to place an online order (e.g., to order more tools, to purchase accessories for the syringe pump, etc.).

The freezer parameters window 606c shows a graph 624 of temperature of the freezer over time and a current temperature 626 of the freezer. The freezer parameters window 606c can include a menu 628 allowing the time axis (x axis) of the graph 624 to be adjusted so data for the freezer can be shown over different periods of time. The freezer parameters window 606c can include a menu 630 allowing the user to add additional users that can access data for the freezer, to access alarm condition information for the freezer, and to adjust settings for the freezer. The freezer parameters window 606c can include a menu 632 allowing the user to selectively zoom the graph 624 in, zoom the graph 624 out, and print the graph 624.

The pH-meter parameters window 606d shows a graph 634 of pH measured by the pH-meter over time and current settings 636 of the pH-meter including pH, voltage, and temperature. The pH-meter parameters window 606d can include a menu 638 allowing the time axis (x axis) of the graph 634 to be adjusted so pH data can be shown over different periods of time. The pH-meter parameters window 606d can include a menu 640 allowing the user to add additional users that can access data for the pH-meter, to access alarm condition information for the pH-meter, and to adjust settings for the pH-meter. The pH-meter parameters window 606d can include a menu 642 allowing the user to selectively zoom the graph 634 in, zoom the graph 634 out, and print the graph 634.

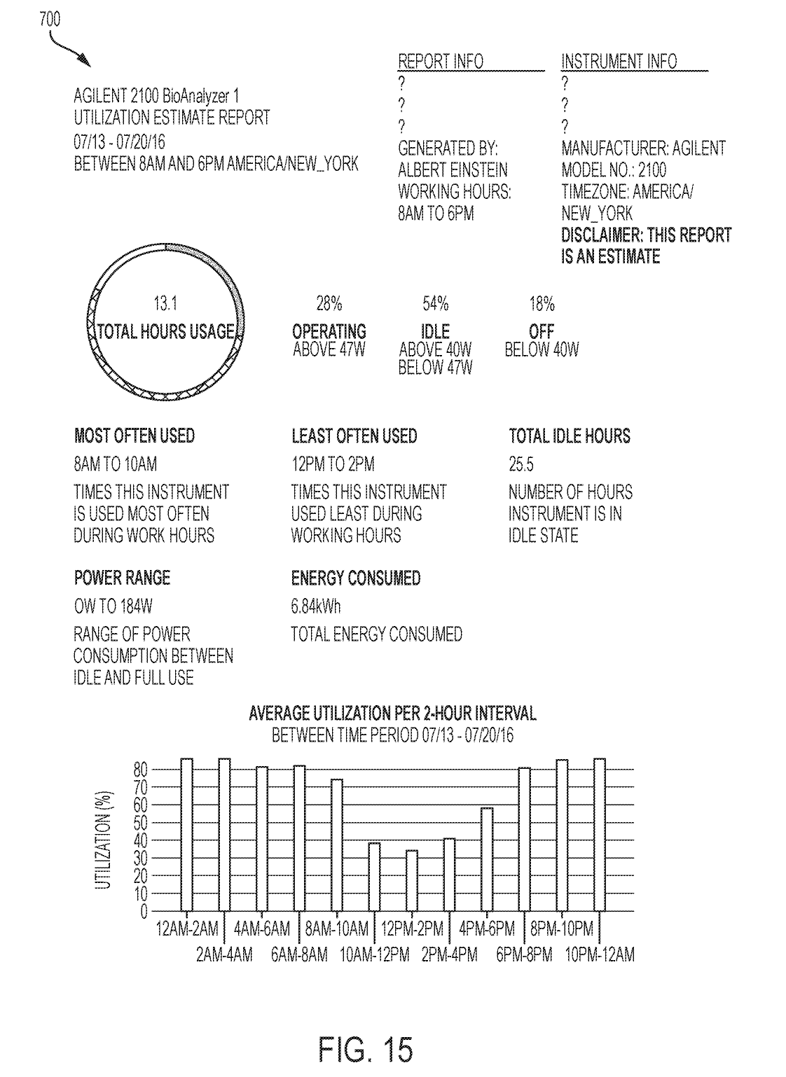

FIG. 15 illustrates another embodiment of a user interface 700 configured to be manipulated by a user and configured to be displayed on a client terminal (not shown) in electronic communication with a control box (not shown) in electronic communication with one or more tools (not shown). The user interface 700 can generally be configured and used similar to the user interface 400 of FIG. 12. The user interface 700 in this illustrated embodiment shows utilization data for a tool, in this case an Agilent 2100 Bioanalyzer.

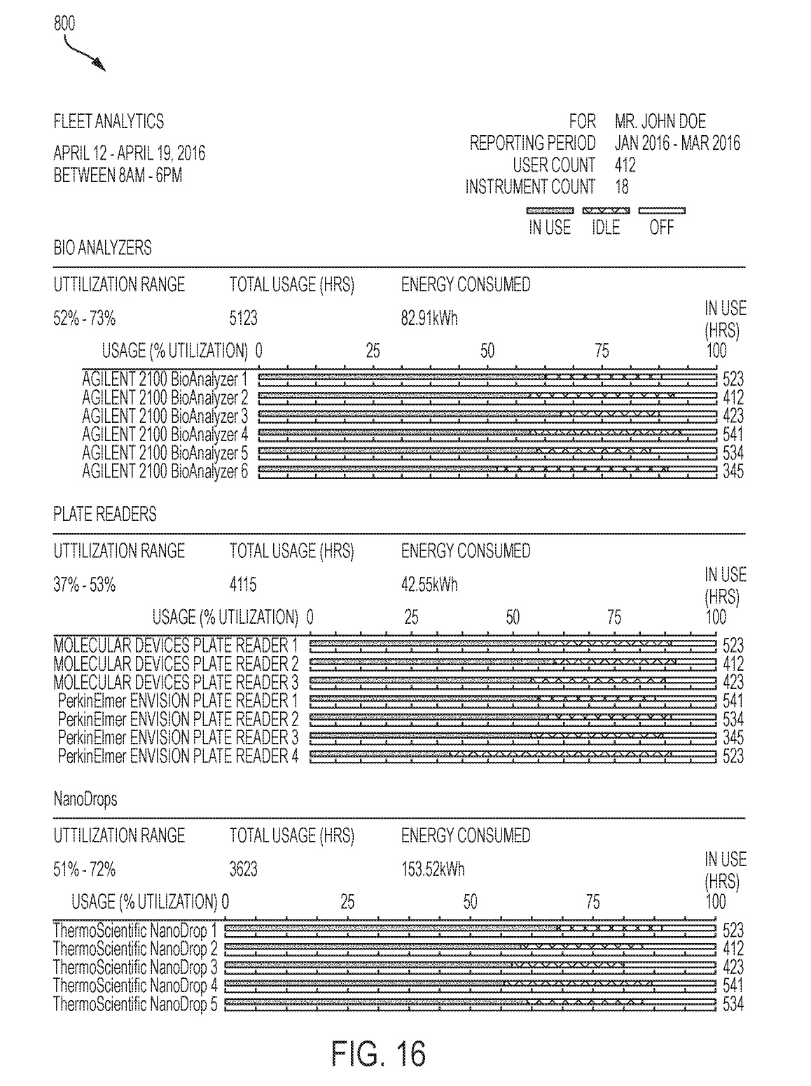

FIG. 16 illustrates yet another embodiment of a user interface 800 configured to be manipulated by a user and configured to be displayed on a client terminal (not shown) in electronic communication with a control box (not shown) in electronic communication with one or more tools (not shown). The user interface 800 can generally be configured and used similar to the user interface 400 of FIG. 12. The user interface 800 in this illustrated embodiment shows utilization data for a fleet of tools being used at a site (e.g., at a lab, etc.), in this case for six bioanalyzers, seven plate readers, and five nanodrops.

Any of the user interfaces described herein as being configured to be in electronic communication with a control box and display information related to thereon can be similarly used with a server in electronic communication therewith instead of or in addition to the control box. In other words, a user interface configured to be manipulated by a user and configured to be displayed on a client terminal can be in electronic communication with a server in electronic communication with one or more tools, such as the server 62 of FIG. 1, the server(s) 120 of FIG. 4, or the server 126 of FIG. 5.

The methods, systems, and devices for monitoring and controlling tools discussed above are described in the context of a scientific (e.g., chemistry, biochemistry, biology, physics, biophysics, medicine, health, agricultural, environmental, computer, engineering, mathematics, statistics, astronomy, geology, meteorology, earth science, geological science, oceanography, etc. and combinations thereof) experiment using one or more scientific tools. The methods, systems, and devices for monitoring and controlling tools have applicability in other contexts.

For non-limiting example, the methods, systems, and devices for monitoring and controlling tools discussed above can be used in the context of a kitchen using one or more cooking tools, e.g., ovens, toasters, toaster ovens, thermometers, mixers, stoves, ice cream maker machines, freezers, mills, timers, etc. The methods, systems, and devices can thus allow cooking processes to be monitored and controlled, which can be helpful for a chef managing multiple kitchens who can remotely monitor and control kitchens in which he/she is not physically present, for a chef overseeing multiple cooking processes at the same time in the same kitchen with each cooking process using its own set of cooking tools that may need adjustment or other attention during its use that the chef may not be able to perform himself/herself in the required time frame for each of the cooking processes, and/or in overseeing a relatively lengthy cooking process (e.g., overnight meat smoking, making stock, etc.) in which one or more people being physically present with the cooking tools throughout the cooking process is less feasible than for shorter cooking processes.

For another non-limiting example, the methods, systems, and devices for monitoring and controlling tools discussed above can be used in the context of a brewery using one or more brewing tools, e.g., thermometers, mixers, mills, burners, timers, etc. The methods, systems, and devices can thus allow brewing processes to be monitored and controlled, which can be helpful for people overseeing multiple breweries in different physical locations and/or in managing brewing processes, which are typically relatively lengthy, throughout their length. Particular aspects related to a brewery that may be allowed by the methods, systems, and devices provided herein include real time view of fermentation; ability to gather and store data as historical records of the brewing process; real time monitoring of brewing; tracking, data logging, and monitoring of the aerobic phase (e.g., dissolved oxygen, turbidity, and optical density); data logging, and monitoring of the anaerobic phase (e.g., CO2 production and flow, ethanol content, sugar content, density, pH, temperature, and foam), and data logging, and monitoring of the settling phase (e.g., turbidity, temperature, and optical density).

For yet another non-limiting example, the methods, systems, and devices for monitoring and controlling tools discussed above can be used in the context of a winery using one or more wine-making tools, e.g., thermometers, mixers, burners, timers, etc. The methods, systems, and devices can thus allow wine-making processes to be monitored and controlled, which can be helpful for people overseeing multiple wineries in different physical locations and/or in managing winery processes, which are typically relatively lengthy, throughout their length.

For still another non-limiting example, the methods, systems, and devices for monitoring and controlling tools discussed above can be used in the context of beekeeping using one or more beekeeping tools, e.g., thermometers, timers, hives, smokers, etc. The methods, systems, and devices can thus allow beekeeping activities to be monitored and controlled, which can be helpful for ensuring consistency among hives and/or for users responsible for monitoring apiaries at different physical sites.

For another non-limiting example, the methods, systems, and devices for monitoring and controlling tools discussed above can be used in the context of a clinical laboratory using one or more clinical tools, e.g., thermometers, timers, burners, mixers, hot plates, etc. The methods, systems, and devices can thus allow clinical activities to be monitored and controlled, which can be helpful for ensuring accurate disease diagnosis using results obtained by the clinical lab and/or for fast identification and addressing of any alarm conditions that occur in the course of the clinical work.

One skilled in the art will appreciate further features and advantages of the invention based on the above-described embodiments. Accordingly, the invention is not to be limited by what has been particularly shown and described, except as indicated by the appended claims. All publications and references cited herein are expressly incorporated herein by reference in their entirety.

1. A device for monitoring and controlling tools, comprising:
a housing having a processor and a wireless communication mechanism disposed therein, the wireless communication mechanism being configured to electronically couple the processor to at least one external tool that is configured to perform at least one of measuring at least one parameter and monitoring at least one parameter, the processor being configured to receive data from the external tool via the wireless communication mechanism that is indicative of the measured at least one parameter and/or the monitored at least one parameter, the processor being configured to provide instructions to the at least one external tool based at least in part on the received data, and the wireless communication mechanism being configured to transmit data to an external device indicative of the data received from the external tool.

2. The device of claim 1, wherein the at least one external tool includes a plurality of external tools, and the processor is configured to switch between controlling different ones of the external tools, the controlling including the processor providing instructions to the one of the external tools that cause the one of the external tools to perform a function.

3. The device of claim 2, wherein the function includes at least one of changing physical position, changing on/off state, and changing the one of the external tool's output.

4. The device of claim 2, wherein the wireless communication mechanism is configured to receive an instruction from a user indicating which one of the external tools the processor is to control.

5. The device of claim 1, wherein the instructions instruct the at least one external tool to perform a function.

6. The device of claim 1, wherein the processor is configured to receive data from a camera visualizing the at least one external tool, the data from the camera being indicative of a condition of the at least one external tool, the wireless communication mechanism being configured to transmit data to the at least one external device indicative of the data received from the camera.

7. The device of claim 6, wherein the instructions instruct the at least one external tool to perform a function based at least in part on the data received from the camera.

8. The device of claim 1, wherein the housing includes at least one port configured to couple to the at least one external tool.

9. The device of claim 1, wherein the housing includes a power control unit.

10. The device of claim 1, wherein the housing includes at least one data port.

11. (canceled)

12. (canceled)

13. The device of claim 1, wherein the at least one external tool includes at least one of a thermometer, a barometer, a humidity measurement device, a camera, a switch, a freezer, an incubator, a syringe pump, a beaker, an autoclave, a hot plate, a hot plate stirrer, a thermocouple, a liquid mixer, a pH measurement device, an oxygen level measurement device, a carbon dioxide measurement device, a voltage measurement device, a current measurement device, a pressure measurement device, a viscosity measurement device, a quantitative polymerase chain reaction (qPCR) measurement device, a weight measurement scale, a power source, a centrifuge, a timer, an oscilloscope, an evaporator, a voltage source, a microscope, a nuclear magnetic resonance (NMR) spectrometer, a Fourier transform infrared (FTIR) spectrometer, a balance, and an orbital shaker.

14. (canceled)

15. (canceled)

16. A device for monitoring and controlling tools, comprising:
a fluid-tight housing including a control unit and a wireless communication unit configured to receive data from a plurality of external scientific tools, the received data being indicative of data sensed by the external scientific tools, the wireless communication unit being configured to provide the received data to the control unit, and the wireless communication unit being configured to transmit instructions from the control unit to the plurality of scientific tools.

17. The device of claim 16, wherein the control unit is configured to cause the wireless communication unit to transmit the instructions to a select one of the scientific tools based on the data sensed by the select one of the scientific tools.

18. The device of claim 17, wherein the control unit is configured to cause the wireless communication unit to transmit the instructions to at least one other of the scientific tools based on the data sensed by the select one of the scientific tools.

19. The device of claim 16, wherein the control unit is configured to cause the wireless communication unit to transmit the instructions to a select one of the scientific tools based on instructions received from a user via the wireless communication unit.

20. The device of claim 16, wherein the housing includes a memory storing a plurality of predetermined actions therein, each of the actions being associated with one of the plurality of external scientific tools; and wherein the processor is configured to determine if the data received from a one of the external scientific tools triggers any one or more of the predetermined actions associated with the one of the external scientific tool, and if so, to execute the triggered one or more predetermined actions.

21. The device of claim 20, wherein the triggered one or more predetermined actions cause the processor to transmit an instruction to the one of the external scientific tools instructing the one of the external scientific tools to perform a function.

22. The device of claim 21, wherein the triggered one or more predetermined actions cause the processor to transmit a second instruction to another one of the external scientific tools instructing the other one of the external scientific tools to perform a function.

23. The device of claim 20, wherein the triggered one or more predetermined actions cause the processor to transmit an instruction to another one of the external scientific tools instructing the other one of the external scientific tools to perform a function.

24. The device of claim 16, wherein the control unit is configured to receive data from a camera visualizing at least one of the scientific tools, the data from the camera being indicative of a condition of the visualized one or more scientific tools; and
wherein the control unit is configured to cause the wireless communication unit to transmit the instructions to at least one of the visualized scientific tools based on the data received from the camera.

25. (canceled)

26. The device of claim 16, wherein the housing includes a network connector configured to physically connect the control unit to a network.

27. (canceled)

28. (canceled)

29. (canceled)

30. The device of claim 16, wherein the external tools include at least two of a thermometer, a barometer, a humidity measurement device, a camera, a switch, a freezer, an incubator, a syringe pump, a beaker, an autoclave, a hot plate, a hot plate stirrer, a thermocouple, a liquid mixer, a pH measurement device, an oxygen level measurement device, a carbon dioxide measurement device, a voltage measurement device, a current measurement device, a pressure measurement device, a viscosity measurement device, a quantitative polymerase chain reaction (qPCR) measurement device, a weight measurement scale, a power source, a centrifuge, a timer, an oscilloscope, an evaporator, a voltage source, a microscope, a nuclear magnetic resonance (NMR) spectrometer, a Fourier transform infrared (FTIR) spectrometer, a balance, and an orbital shaker.

31-79. (canceled)
